(19) United States
(12) Patent Application Publication
(10) Pub. No.: US 2023/0177349 A1
(43) Pub. Date: Jun. 8, 2023

(54) FEDERATED LEARNING OPTIMIZATIONS

(71) Applicant: Intel Corporation, Santa Clara, CA (US)

(72) Inventors: Ravikumar Balakrishnan, Beaverton, OR (US); Nageen Himayat, Fremont, CA (US); Mustafa Riza Akdeniz, San Jose, CA (US); Sagar Dhakal, Los Altos, CA (US); Arjun Anand, Milpitas, CA (US); Hesham Mostafa, San Diego, CA (US)

(73) Assignee: Intel Corporation, Santa Clara, CA (US)

(21) Appl. No.: 17/920,839

(22) PCT Filed: May 29, 2021
(86) PCT No.: PCT/US2021/035042

§ 371 Date: Oct. 24, 2022

Related U.S. Application Data
(60) Provisional application No. 63/053,554, filed on Jul. 17, 2020.
(60) Provisional application No. 62/704,885, filed on Jun. 1, 2020.

(51) Int. Cl. G06N 3/098; H04L 67/10

(52) U.S. Cl. CPC G06N 3/098; H04L 67/10

(57) ABSTRACT

The apparatus of an edge computing node, a system, a method and a machine-readable medium. The apparatus includes a processor to cause an initial set of weights for a global machine learning (ML) model to be transmitted a set of client compute nodes of the edge computing network; process Hessians computed by each of the client compute nodes based on a dataset stored on the client compute node; evaluate a gradient expression for the ML model based on a second dataset and an updated set of weights received from the client compute nodes; and generate a meta-updated set of weights for the global model based on the initial set of weights, the Hessians received, and the evaluated gradient expression.

### CROSS REFERENCE TO RELATED APPLICATIONS

This application claims the benefit of, and priority from, U.S. Provisional Patent Application No. 62/704,885, entitled “DISTRIBUTED META-LEARNING FOR FEDERATED LEARNING WITH NON-IID (INDEPENDENT AND IDENTICALLY DISTRIBUTED) DATA” and filed Jun. 1, 2020 and U.S. Provisional Patent Application No. 63/053,554, entitled “OPTIMIZATIONS FOR FEDERATED LEARNING” and filed Jul. 17, 2020, the entire disclosures of which are incorporated herein by reference.

### BACKGROUND

Edge computing, at a general level, refers to the implementation, coordination, and use of computing and resources at locations closer to the “edge” or collection of “edges” of the network. The purpose of this arrangement is to improve total cost of ownership, reduce application and network latency, reduce network backhaul traffic and associated energy consumption, improve service capabilities, and improve compliance with security or data privacy requirements (especially as compared to conventional cloud computing). Components that can perform edge computing operations (“edge nodes”) can reside in whatever location needed by the system architecture or ad hoc service (e.g., in a high performance compute data center or cloud installation; a designated edge node server, an enterprise server, a roadside server, a telecom central office; or a local or peer at-the-edge device being served consuming edge services).

Applications that have been adapted for edge computing include but are not limited to virtualization of traditional network functions (e.g., to operate telecommunications or Internet services) and the introduction of next-generation features and services (e.g., to support 5G network services). Use-cases which are projected to extensively utilize edge computing include connected self-driving cars, surveillance, Internet of Things (IoT) device data analytics, video encoding and analytics, location aware services, device sensing in Smart Cities, among many other network and compute intensive services.

Edge computing may, in some scenarios, offer or host a cloud-like distributed service, to offer orchestration and management for applications, coordinated service instances and machine learning, such as federated machine learning, among many types of storage and compute resources. Edge computing is also expected to be closely integrated with existing use cases and technology developed for IoT and Fog/distributed networking configurations, as endpoint devices, clients, and gateways attempt to access network resources and applications at locations closer to the edge of the network.

Mechanisms are needed to address the challenges of developing globally accurate learning models over wireless edge networks with distributed data, and online, distributed algorithms deployed in real-time and using compute, communication and data resources that are heterogenous, mobile and that change dynamically.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an overview of an edge cloud configuration for edge computing.

FIG. 2 illustrates operational layers among endpoints, an edge cloud, and cloud computing environments.

FIG. 3 illustrates an example approach for networking and services in an edge computing system.

FIG. 4 illustrates deployment of a virtual edge configuration in an edge computing system operated among multiple edge nodes and multiple tenants.

FIG. 5 illustrates various compute arrangements deploying containers in an edge computing system.

FIG. 6 illustrates a compute and communication use case involving mobile access to applications in an edge computing system.

FIG. 7 illustrates an example mobile edge system reference architecture, arranged according to an ETSI Multi-Access Edge Computing (MEC) specification.

FIG. 8 provides a further overview of example components within a computing device in an edge computing system.

FIG. 9 illustrates an overview of layers of distributed compute deployed among an edge computing system, according to an example;

FIG. 10 illustrates network connectivity in non-terrestrial (satellite) and terrestrial (mobile cellular network) settings, according to an example.

FIG. 11 illustrates an example software distribution platform to distribute software, such as the example computer readable instructions FIG. 8, to one or more devices.

FIG. 12 depicts an example of federated learning in an edge computing network system.

FIG. 13 illustrates a flow diagram of an example process for performing federated meta-learning using a clustering algorithm.

FIG. 14 illustrates a flow diagram of another example process for performing federated meta-learning using a clustering algorithm.

FIG. 15 illustrates a flow diagram of another example process for performing federated meta-learning using a clustering algorithm.

FIG. 16 illustrates a flow diagram of another example process for performing federated meta-learning using a clustering algorithm.

FIGS. 17-18 illustrate experimental results of different federated meta-learning approaches.

FIG. 19 illustrates an example server-based approach for data batch size selection in federated learning environments.

FIG. 20 illustrates an example client-based approach for data batch size selection in federated learning environments.

FIG. 21 illustrates an example reinforcement learning (RL) model that may be used in federated learning embodiments.

FIG. 22 illustrates an example training architecture for RL based optimization of federated learning.

### DETAILED DESCRIPTION

Embodiments will focus on learning that is collaborative, hierarchical, and that uses distributed datasets/datapoints and processing while aiming to preserve privacy. Some embodiments advantageously draw on opportunities provided by resource rich, real-time compute environments offered by wireless edge networks to exploit sensing, compute, communication and storage resources, to lower latency and communication costs including by way of radio resource management, to increase privacy (for example by transferring results instead of raw data), to automate and scale ML training, to exploit wireless for computation including over the air combining, and to promote multi-stage learning.

Sections A through G. below will provide an overview of configurations for edge computing, such as wireless edge computing, including, respectively, overviews of edge computing, usage of containers in edge computing, mobility and multi-access edge computing (MEC) in edge computing settings, computing architectures and systems, machine readable medium and distributed software instructions, a satellite edge connectivity use case, software distribution in edge computing settings. Section H. provides an overview of machine learning in edge computing networks.

Sections H through P provide a detailed description of some respective demonstrative embodiments that address challenges of developing globally accurate learning models over wireless edge networks with distributed data. Aspects of embodiments described in any one of Sections H. through P. may be combined with other aspects described in any one of the same Sections as would be recognized by one skilled in the art. Embodiments of Sections H through P may be deployed or implemented using any of the configurations or environments described in any of Sections A through G described below.

### A. Overviews of Edge Computing

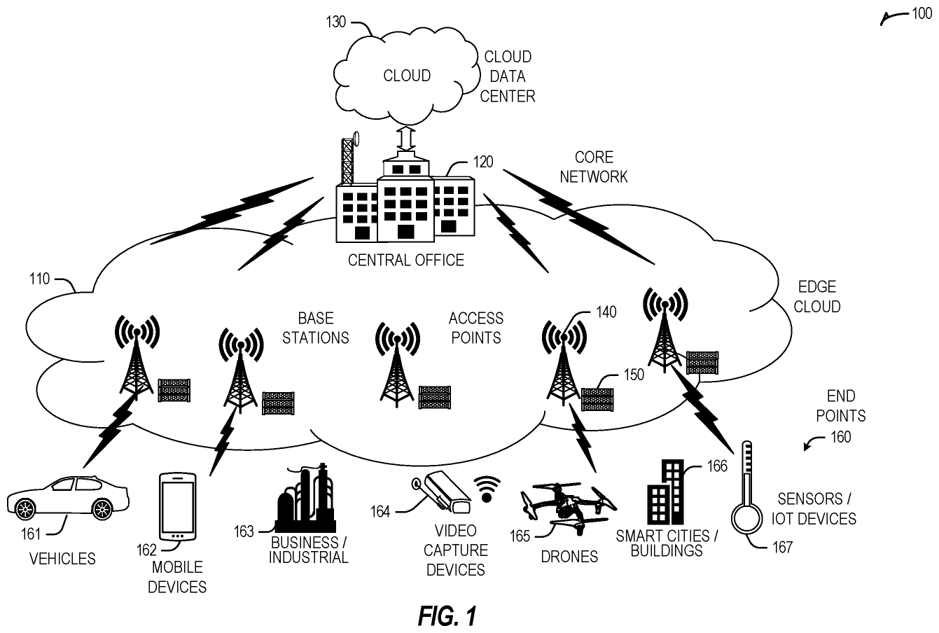

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power might be constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, which may use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

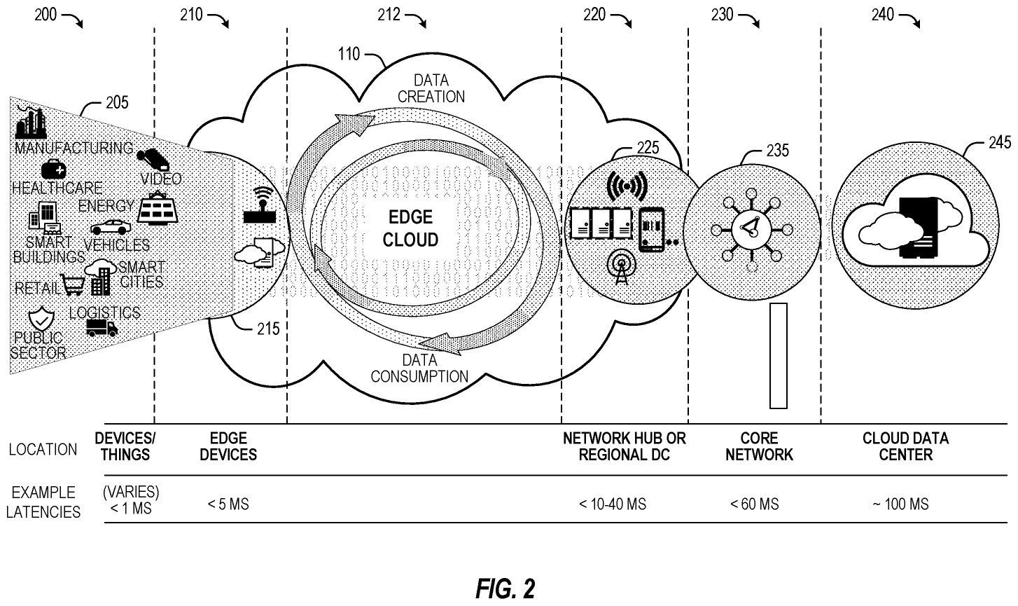

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge may be resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the Examples provided herein, a client computing node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge computing nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc., which may be compatible with Open RAN (O-RAN) specifications promulgated by the O-RAN Alliance), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

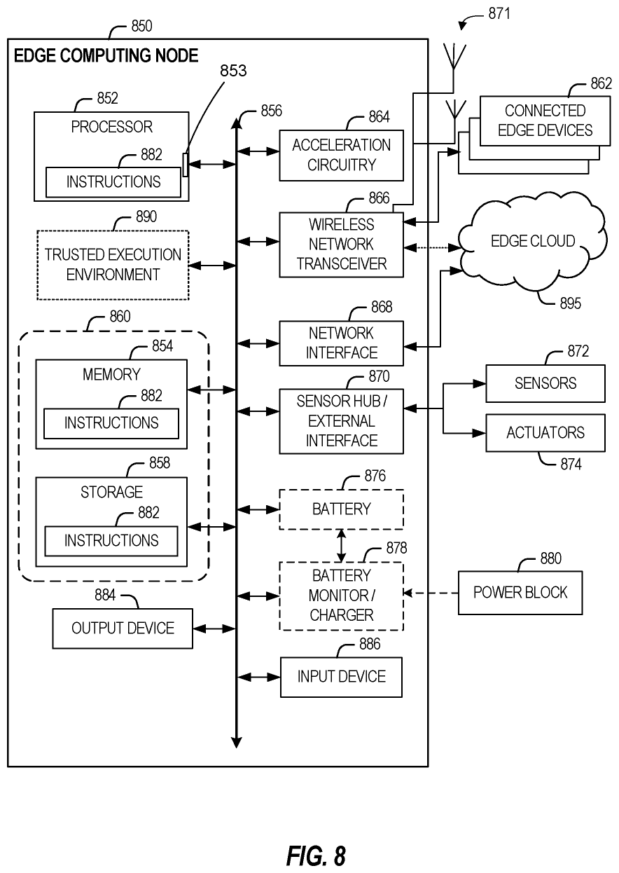

The network components of the edge cloud 110 may be servers, multi-tenant servers, appliance computing devices, and/or any other type of computing devices. For example, the edge cloud 110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, sleds, etc.). A server rack may refer to a structure that is designed specifically to house technical equipment including routers, switches, hubs, servers (including CPU and/or GPU-based compute devices), data storage devices (e.g., storage area network (SAN) devices), or other types of computing or networking devices. The rack may make it possible to securely hold multiple pieces of equipment in one area. In some cases, the rack may include one or more sleds. A sled may refer to a housing that allows for a number of various compute, GPU, and/or storage devices to be housed in a position of a rack (e.g., a 4 unit (4U)-sized or other-sized unit). The sled may allow for the devices housed within it to be hot-swappable in some instances. Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 8. The edge cloud 110 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

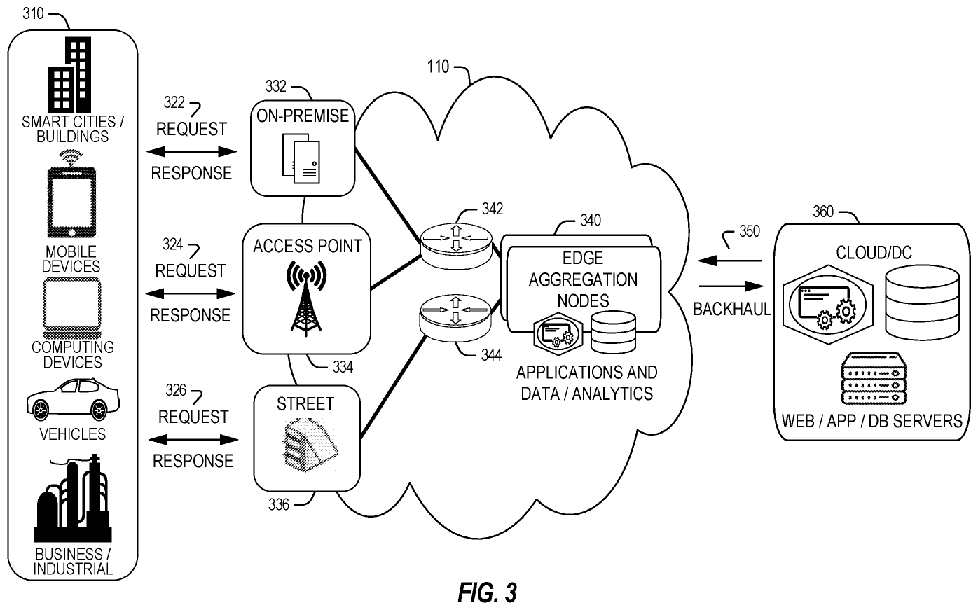

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

### B. Usage of Containers in Edge Computing

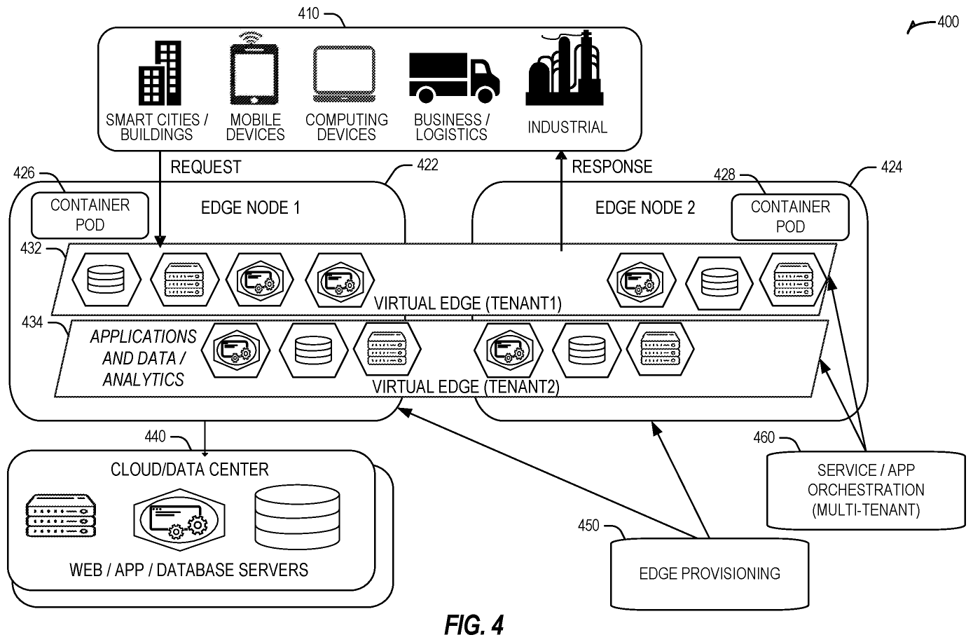

FIG. 4 illustrates deployment and orchestration for virtualized and container-based edge configurations across an edge computing system operated among multiple edge nodes and multiple tenants (e.g., users, providers) which use such edge nodes. Specifically, FIG. 4 depicts coordination of a first edge node 422 and a second edge node 424 in an edge computing system 400, to fulfill requests and responses for various client endpoints 410 (e.g., smart cities/building systems, mobile devices, computing devices, business/logistics systems, industrial systems, etc.), which access various virtual edge instances. Here, the virtual edge instances 432, 434 provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers a first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460.

It should be understood that some of the devices in 410 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes may use containers, FaaS engines, Servlets, servers, or other computation abstraction that may be partitioned according to a DICE layering and fan-out structure to support a RoT context for each. Accordingly, the respective RoTs spanning devices 410, 422, and 440 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 432, 434 are partitioned according to the needs of each container.

With the use of container pods, a pod controller oversees the partitioning and allocation of containers and resources. The pod controller receives instructions from an orchestrator (e.g., orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid potential resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked prior to the second pod executing.

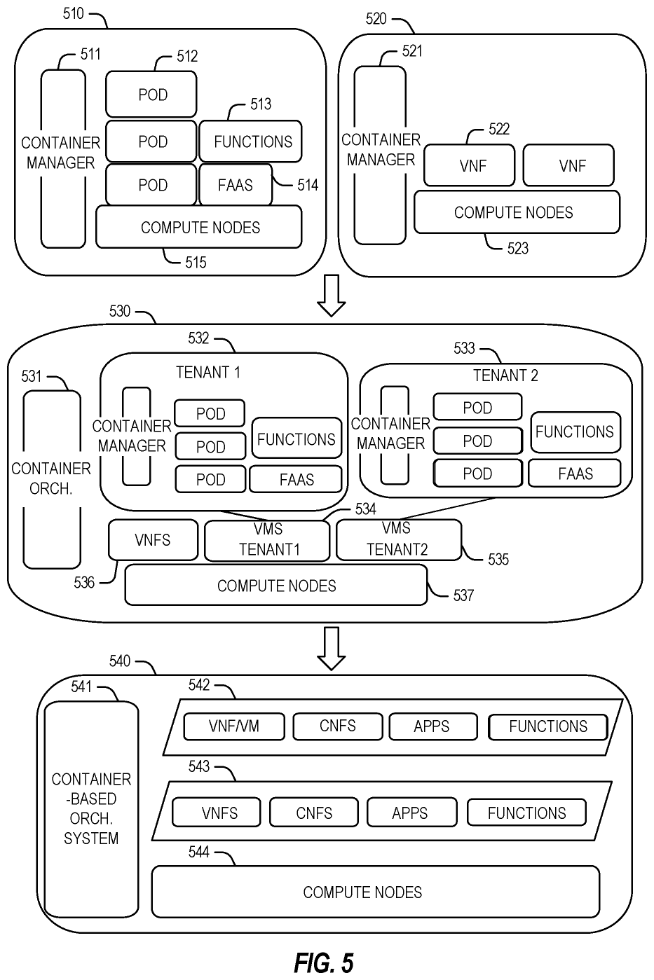

FIG. 5 illustrates additional compute arrangements deploying containers in an edge computing system. As a simplified example, system arrangements 510, 520 depict settings in which a pod controller (e.g., container managers 511, 521, and container orchestrator 531) is adapted to launch containerized pods, functions, and functions-as-a-service instances through execution via computing nodes (515 in arrangement 510), or to separately execute containerized virtualized network functions through execution via computing nodes (523 in arrangement 520). This arrangement is adapted for use of multiple tenants in system arrangement 530 (using computing nodes 537), where containerized pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside the execution of virtualized network functions). This arrangement is further adapted for use in system arrangement 540, which provides containers 542, 543, or execution of the various functions, applications, and functions on computing nodes 544, as coordinated by an container-based orchestration system 541.

The system arrangements of depicted in FIG. 5 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 5, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon (SDSi) may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

### C. Mobility and Multi-Access Edge Computing (MEC) in Edge COMPUTING SETTINGS

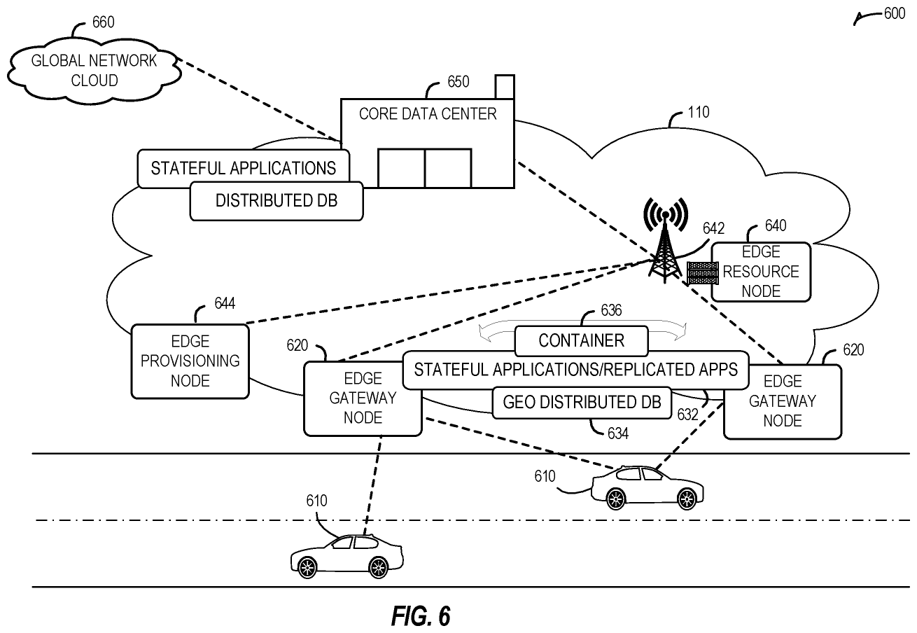

It should be appreciated that the edge computing systems and arrangements discussed herein may be applicable in various solutions, services, and/or use cases involving mobility. As an example, FIG. 6 shows a simplified vehicle compute and communication use case involving mobile access to applications in an edge computing system 600 that implements an edge cloud 110. In this use case, respective client computing nodes 610 may be embodied as in-vehicle compute systems (e.g., in-vehicle navigation and/or infotainment systems) located in corresponding vehicles which communicate with the edge gateway nodes 620 during traversal of a roadway. For instance, the edge gateway nodes 620 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client computing node 610 and a particular edge gateway device 620 may propagate so as to maintain a consistent connection and context for the client computing node 610. Likewise, mobile edge nodes may aggregate at the high priority services or according to the throughput or latency resolution requirements for the underlying service(s) (e.g., in the case of drones). The respective edge gateway devices 620 include an amount of processing and storage capabilities and, as such, some processing and/or storage of data for the client computing nodes 610 may be performed on one or more of the edge gateway devices 620.

The edge gateway devices 620 may communicate with one or more edge resource nodes 640, which are illustratively embodied as compute servers, appliances or components located at or in a communication base station 642 (e.g., a base station of a cellular network). As discussed above, the respective edge resource nodes 640 include an amount of processing and storage capabilities and, as such, some processing and/or storage of data for the client computing nodes 610 may be performed on the edge resource node 640. For example, the processing of data that is less urgent or important may be performed by the edge resource node 640, while the processing of data that is of a higher urgency or importance may be performed by the edge gateway devices 620 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 640 also communicate with the core data center 650, which may include compute servers, appliances, and/or other components located in a central location (e.g., a central office of a cellular communication network). The core data center 650 may provide a gateway to the global network cloud 660 (e.g., the Internet) for the edge cloud 110 operations formed by the edge resource node(s) 640 and the edge gateway devices 620. Additionally, in some examples, the core data center 650 may include an amount of processing and storage capabilities and, as such, some processing and/or storage of data for the client compute devices may be performed on the core data center 650 (e.g., processing of low urgency or importance, or high complexity).

The edge gateway nodes 620 or the edge resource nodes 640 may offer the use of stateful applications 632 and a geographic distributed database 634. Although the applications 632 and database 634 are illustrated as being horizontally distributed at a layer of the edge cloud 110, it will be understood that resources, services, or other components of the application may be vertically distributed throughout the edge cloud (including, part of the application executed at the client computing node 610, other parts at the edge gateway nodes 620 or the edge resource nodes 640, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 636 (or pod of containers) may be flexibly migrated from an edge node 620 to other edge nodes (e.g., 620, 640, etc.) such that the container with an application and workload does not need to be reconstituted, re-compiled, re-interpreted in order for migration to work. However, in such settings, there may be some remedial or “swizzling” translation operations applied. For example, the physical hardware at node 640 may differ from edge gateway node 620 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format, or may involve mapping interfaces and operations. A pod controller may be used to drive the interface mapping as part of the container lifecycle, which includes migration to/from different hardware environments.

The scenarios encompassed by FIG. 6 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 620, some others at the edge resource node 640, and others in the core data center 650 or global network cloud 660.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The edge computing system 600 can include or be in communication with an edge provisioning node 644. The edge provisioning node 644 can distribute software such as the example computer readable instructions 882 of FIG. 8, to various receiving parties for implementing any of the methods described herein. The example edge provisioning node 644 may be implemented by any computer server, home server, content delivery network, virtual server, software distribution system, central facility, storage device, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 644. For example, the entity that owns and/or operates the edge provisioning node 644 may be a developer, a seller, and/or a licensor (or a customer and/or consumer thereof) of software instructions such as the example computer readable instructions 882 of FIG. 8. The receiving parties may be consumers, service providers, users, retailers, OEMs, etc., who purchase and/or license the software instructions for use and/or re-sale and/or sub-licensing.

In an example, edge provisioning node 644 includes one or more servers and one or more storage devices. The storage devices host computer readable instructions such as the example computer readable instructions 882 of FIG. 8, as described below. Similarly to edge gateway devices 620 described above, the one or more servers of the edge provisioning node 644 are in communication with a base station 642 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third-party payment entity. The servers enable purchasers and/or licensors to download the computer readable instructions 882 from the edge provisioning node 644. For example, the software instructions, which may correspond to the example computer readable instructions 882 of FIG. 8, may be downloaded to the example processor platform/s, which is to execute the computer readable instructions 882 to implement the methods described herein.

In some examples, the processor platform(s) that execute the computer readable instructions 882 can be physically located in different geographic locations, legal jurisdictions, etc. In some examples, one or more servers of the edge provisioning node 644 periodically offer, transmit, and/or force updates to the software instructions (e.g., the example computer readable instructions 882 of FIG. 8) to ensure improvements, patches, updates, etc. are distributed and applied to the software instructions implemented at the end user devices. In some examples, different components of the computer readable instructions 882 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

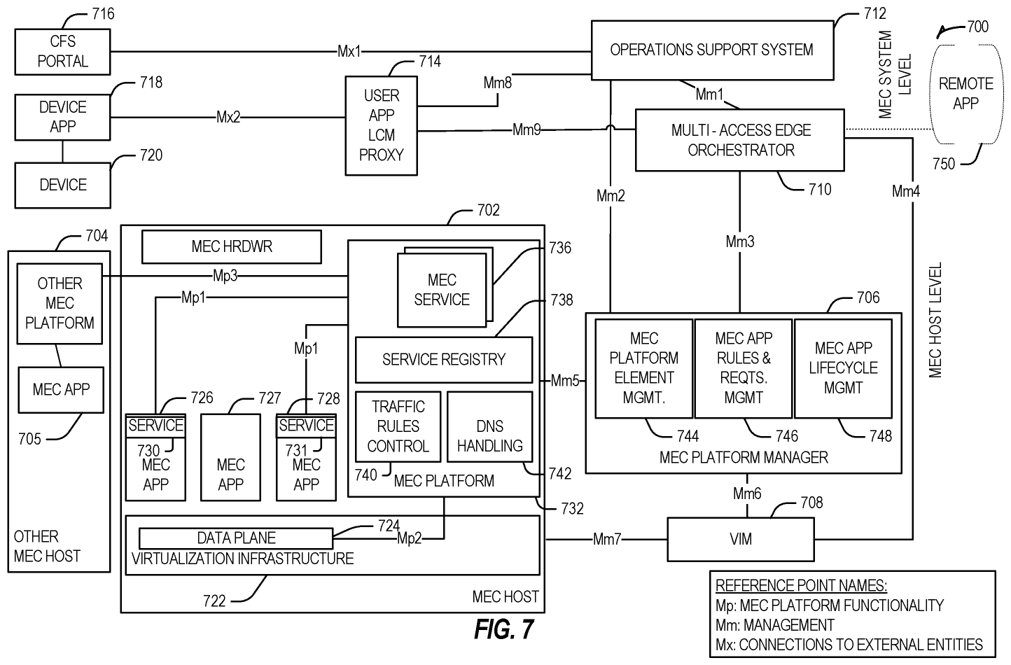

FIG. 7 illustrates a mobile edge system reference architecture (or MEC architecture) 700, such as is indicated by ETSI MEC specifications. FIG. 7 specifically illustrates a MEC architecture 700 with MEC hosts 702 and 704 providing functionalities in accordance with the ETSI GS MEC-003 specification. In some aspects, enhancements to the MEC platform 732 and the MEC platform manager 706 may be used for providing specific computing functions within the MEC architecture 700.

Referring to FIG. 7, the MEC network architecture 700 can include MEC hosts 702 and 704, a virtualization infrastructure manager (VIM) 708, an MEC platform manager 706, an MEC orchestrator 710, an operations support system 712, a user app proxy 714, a UE app 718 running on UE 720, and CFS portal 716. The MEC host 702 can include a MEC platform 732 with filtering rules control component 740, a DNS handling component 742, a service registry 738, and MEC services 736. The MEC services 736 can include at least one scheduler, which can be used to select resources for instantiating MEC apps (or NFVs) 726, 727, and 728 upon virtualization infrastructure 722. The MEC apps 726 and 728 can be configured to provide services 730 and 731, which can include processing network communications traffic of different types associated with one or more wireless connections (e.g., connections to one or more RAN (e.g., O-RAN) or telecom-core network entities). The MEC app 705 instantiated within MEC host 704 can be similar to the MEC apps 726-7728 instantiated within MEC host 702. The virtualization infrastructure 722 includes a data plane 724 coupled to the MEC platform via an MP2 interface. Additional interfaces between various network entities of the MEC architecture 700 are illustrated in FIG. 7.

The MEC platform manager 706 can include MEC platform element management component 744, MEC app rules and requirements management component 746, and MEC app lifecycle management component 748. The various entities within the MEC architecture 700 can perform functionalities as disclosed by the ETSI GS MEC-003 specification.

In some aspects, the remote application (or app) 750 is configured to communicate with the MEC host 702 (e.g., with the MEC apps 726-7728) via the MEC orchestrator 710 and the MEC platform manager 706.

### D. Computing Architectures and Systems

In further examples, any of the computing nodes or devices discussed with reference to the present edge computing systems and environment may be fulfilled based on the components depicted in FIG. 8. Respective edge computing nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In a more detailed example, FIG. 8 illustrates a block diagram of an example of components that may be present in an edge computing node 850 for implementing the techniques (e.g., operations, processes, methods, and methodologies) described herein. The edge computing node 850 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 850, or as components otherwise incorporated within a chassis of a larger system.

The edge computing device 850 may include processing circuitry in the form of a processor 852, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 852 may be a part of a system on a chip (SoC) in which the processor 852 and other components are formed into a single integrated circuit, or a single package, such as the Edison™ or Galileo™ SoC boards from Intel Corporation, Santa Clara, Calif. As an example, the processor 852 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-13 processor from Apple® Inc., a Snapdragon™ processor from Qualcomm® Technologies, Inc., or an OMAP™ processor from Texas Instruments, Inc. The processor 852 and accompanying circuitry may be provided in a single socket form factor, multiple socket form factor, or a variety of other formats, including in limited hardware configurations or configurations that include fewer than all elements shown in FIG. 8.

The processor 852 may communicate with a system memory 854 over an interconnect 856 (e.g., a bus) through an interconnect interface 853 of the processor. The interconnect interface 853 may include any input/output connection of the processor 852 that allows the processor 852 to be connected through interconnect 856 to other components of the edge computing node 850. The processor 852 may include one or more processors and/or any type of processing circuitry. Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples, the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 858 may also couple to the processor 852 via the interconnect 856. In an example, the storage 858 may be implemented via a solid-state disk drive (SSDD). Other devices that may be used for the storage 858 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 858 may be on-die memory or registers associated with the processor 852. However, in some examples, the storage 858 may be implemented using a micro hard disk drive (HDD). Further, any number of new technologies may be used for the storage 858 in addition to, or instead of, the technologies described, such resistance change memories, phase change memories, holographic memories, or chemical memories, among others.

The components may communicate over the interconnect 856. The interconnect 856 may include any number of technologies, including industry standard architecture (ISA), extended ISA (EISA), peripheral component interconnect (PCI), peripheral component interconnect extended (PCIx), PCI express (PCIe), or any number of other technologies. The interconnect 856 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 856 may couple the processor 852 to a transceiver 866, for communications with the connected edge devices 862. The transceiver 866 may be coupled to one or more antennas 871 of the edge computing node 850 to enable the edge computing node to wirelessly communicate with other edge computing nodes or other nodes in the wireless edge network. The transceiver 866 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 862. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 866 (or multiple transceivers) may communicate using multiple standards or radios for communications at a different range. For example, the edge computing node 850 may communicate with close devices, e.g., within about 10 meters, using a local transceiver based on Bluetooth Low Energy (BLE), or another low power radio, to save power. More distant connected edge devices 862, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 866 (e.g., a radio transceiver) may be included to communicate with devices or services in a cloud (e.g., an edge cloud 895) via local or wide area network protocols. The wireless network transceiver 866 may be a low-power wide-area (LPWA) transceiver that follows the IEEE 802.15.4, or IEEE 802.15.4g standards, among others. The edge computing node 850 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 866, as described herein. For example, the transceiver 866 may include a cellular transceiver that uses spread spectrum (SPA/SAS) communications for implementing high-speed communications. Further, any number of other protocols may be used, such as Wi-Fi® networks for medium speed communications and provision of network communications. The transceiver 866 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 868 may be included to provide a wired communication to nodes of the edge cloud 895 or to other devices, such as the connected edge devices 862 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 868 may be included to enable connecting to a second network, for example, a first NIC 868 providing communications to the cloud over Ethernet, and a second NIC 868 providing communications to other devices over another type of network.

Given the variety of types of applicable communications from the device to another component or network, applicable communications circuitry used by the device may include or be embodied by any one or more of components 864, 866, 868, or 870. Accordingly, in various examples, applicable means for communicating (e.g., receiving, transmitting, etc.) may be embodied by such communications circuitry.

The edge computing node 850 may include or be coupled to acceleration circuitry 864, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 856 may couple the processor 852 to a sensor hub or external interface 870 that is used to connect additional devices or subsystems. The devices may include sensors 872, such as accelerometers, level sensors, flow sensors, optical light sensors, camera sensors, temperature sensors, global navigation system (e.g., GPS) sensors, pressure sensors, barometric pressure sensors, and the like. The hub or interface 870 further may be used to connect the edge computing node 850 to actuators 874, such as power switches, valve actuators, an audible sound generator, a visual warning device, and the like.

In some optional examples, various input/output (I/O) devices may be present within or connected to, the edge computing node 850. For example, a display or other output device 884 may be included to show information, such as sensor readings or actuator position. An input device 886, such as a touch screen or keypad may be included to accept input. An output device 884 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 850. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 876 may power the edge computing node 850, although, in examples in which the edge computing node 850 is mounted in a fixed location, it may have a power supply coupled to an electrical grid, or the battery may be used as a backup or for temporary capabilities. The battery 876 may be a lithium ion battery, or a metal-air battery, such as a zinc-air battery, an aluminum-air battery, a lithium-air battery, and the like.

A battery monitor/charger 878 may be included in the edge computing node 850 to track the state of charge (SoCh) of the battery 876, if included. The battery monitor/charger 878 may be used to monitor other parameters of the battery 876 to provide failure predictions, such as the state of health (SoH) and the state of function (SoF) of the battery 876. The battery monitor/charger 878 may include a battery monitoring integrated circuit, such as an LTC4020 or an LT7990 from Linear Technologies, an ADT7488A from ON Semiconductor of Phoenix Ariz., or an IC from the UCD90xxx family from Texas Instruments of Dallas, Tex. The battery monitor/charger 878 may communicate the information on the battery 876 to the processor 852 over the interconnect 856. The battery monitor/charger 878 may also include an analog-to-digital (ADC) converter that enables the processor 852 to directly monitor the voltage of the battery 876 or the current flow from the battery 876. The battery parameters may be used to determine actions that the edge computing node 850 may perform, such as transmission frequency, mesh network operation, sensing frequency, and the like.

A power block 880, or other power supply coupled to a grid, may be coupled with the battery monitor/charger 878 to charge the battery 876. In some examples, the power block 880 may be replaced with a wireless power receiver to obtain the power wirelessly, for example, through a loop antenna in the edge computing node 850. A wireless battery charging circuit, such as an LTC4020 chip from Linear Technologies of Milpitas, Calif., among others, may be included in the battery monitor/charger 878. The specific charging circuits may be selected based on the size of the battery 876, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 858 may include instructions 882 in the form of software, firmware, or hardware commands to implement the techniques described herein. Although such instructions 882 are shown as code blocks included in the memory 854 and the storage 858, it may be understood that any of the code blocks may be replaced with hardwired circuits, for example, built into an application specific integrated circuit (ASIC).

In an example, the instructions 882 provided via the memory 854, the storage 858, or the processor 852 may be embodied as a non-transitory, machine-readable medium 860 including code to direct the processor 852 to perform electronic operations in the edge computing node 850. The processor 852 may access the non-transitory, machine-readable medium 860 over the interconnect 856. For instance, the non-transitory, machine-readable medium 860 may be embodied by devices described for the storage 858 or may include specific storage units such as optical disks, flash drives, or any number of other hardware devices. The non-transitory, machine-readable medium 860 may include instructions to direct the processor 852 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 882 on the processor 852 (separately, or in combination with the instructions 882 of the machine readable medium 860) may configure execution or operation of a trusted execution environment (TEE) 890. In an example, the TEE 890 operates as a protected area accessible to the processor 852 for secure execution of instructions and secure access to data. Various implementations of the TEE 890, and an accompanying secure area in the processor 852 or the memory 854 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 850 through the TEE 890 and the processor 852.

### E. Machine Readable Medium and Distributed Software Instructions

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

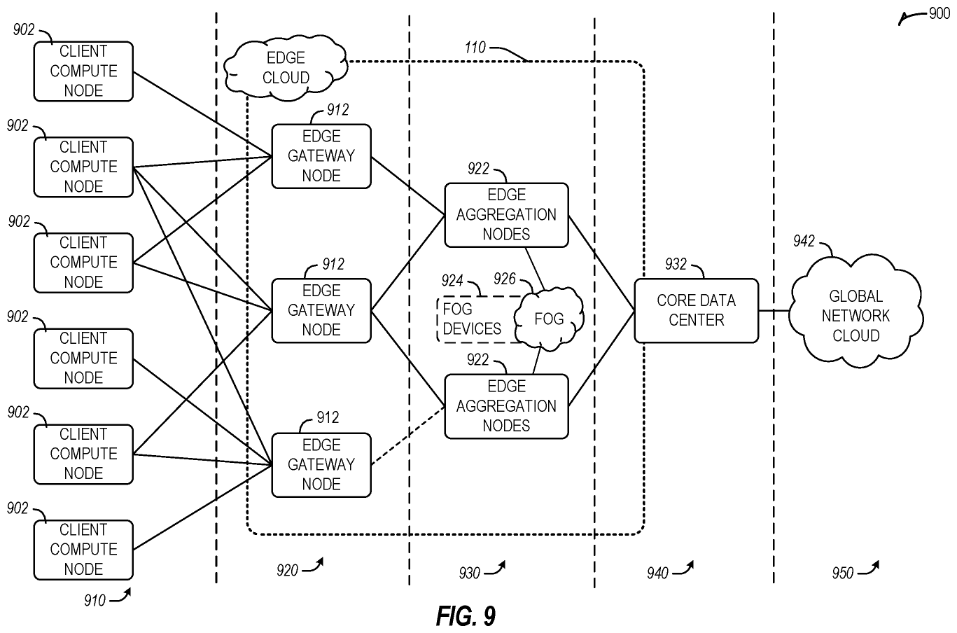

At a more generic level, an edge computing system may be described to encompass any number of deployments operating in an edge cloud 110, which provide coordination from client and distributed computing devices. FIG. 9 provides a further abstracted overview of layers of distributed compute deployed among an edge computing environment for purposes of illustration.

FIG. 9 generically depicts an edge computing system for providing edge services and applications to multi-stakeholder entities, as distributed among one or more client computing nodes 902, one or more edge gateway nodes 912, one or more edge aggregation nodes 922, one or more core data centers 932, and a global network cloud 942, as distributed across layers of the network. The implementation of the edge computing system may be provided at or on behalf of a telecommunication service provider (“telco”, or “TSP”), internet-of-things service provider, cloud service provider (CSP), enterprise entity, or any other number of entities.

Each node or device of the edge computing system is located at a particular layer corresponding to layers 910, 920, 930, 940, 950. For example, the client computing nodes 902 are each located at an endpoint layer 910, while each of the edge gateway nodes 912 are located at an edge devices layer 920 (local level) of the edge computing system. Additionally, each of the edge aggregation nodes 922 (and/or fog devices 924, if arranged or operated with or among a fog networking configuration 926) are located at a network access layer 930 (an intermediate level). Fog computing (or “fogging”) generally refers to extensions of cloud computing to the edge of an enterprise's network, typically in a coordinated distributed or multi-node network. Some forms of fog computing provide the deployment of compute, storage, and networking services between end devices and cloud computing data centers, on behalf of the cloud computing locations. Such forms of fog computing provide operations that are consistent with edge computing as discussed herein; many of the edge computing aspects discussed herein are applicable to fog networks, fogging, and fog configurations. Further, aspects of the edge computing systems discussed herein may be configured as a fog, or aspects of a fog may be integrated into an edge computing architecture.

The core data center 932 is located at a core network layer 940 (e.g., a regional or geographically-central level), while the global network cloud 942 is located at a cloud data center layer 950 (e.g., a national or global layer). The use of “core” is provided as a term for a centralized network location—deeper in the network—which is accessible by multiple edge nodes or components; however, a “core” does not necessarily designate the “center” or the deepest location of the network. Accordingly, the core data center 932 may be located within, at, or near the edge cloud 110.

Although an illustrative number of client computing nodes 902, edge gateway nodes 912, edge aggregation nodes 922, core data centers 932, global network clouds 942 are shown in FIG. 9, it should be appreciated that the edge computing system may include more or fewer devices or systems at each layer. Additionally, as shown in FIG. 9, the number of components of each layer 910, 920, 930, 940, 950 generally increases at each lower level (i.e., when moving closer to endpoints). As such, one edge gateway node 912 may service multiple client computing nodes 902, and one edge aggregation node 922 may service multiple edge gateway nodes 912.

Consistent with the examples provided herein, each client computing node 902 may be embodied as any type of end point component, device, appliance, or “thing” capable of communicating as a producer or consumer of data. Further, the label “node” or “device” as used in the edge computing system 900 does not necessarily mean that such node or device operates in a client or agent/minion/follower role; rather, any of the nodes or devices in the edge computing system 900 refer to individual entities, nodes, or subsystems which include discrete or connected hardware or software configurations to facilitate or use the edge cloud 110.

As such, the edge cloud 110 is formed from network components and functional features operated by and within the edge gateway nodes 912 and the edge aggregation nodes 922 of layers 920, 930, respectively. The edge cloud 110 may be embodied as any type of network that provides edge computing and/or storage resources which are proximately located to radio access network (RAN) capable endpoint devices (e.g., mobile computing devices, IoT devices, smart devices, etc., which may be compatible with O-RAN specifications), which are shown in FIG. 9 as the client computing nodes 902. In other words, the edge cloud 110 may be envisioned as an “edge” which connects the endpoint devices and traditional mobile network access points that serves as an ingress point into service provider core networks, including carrier networks (e.g., Global System for Mobile Communications (GSM) networks, Long-Term Evolution (LTE) networks, 5G networks, etc.), while also providing storage and/or compute capabilities. Other types and forms of network access (e.g., Wi-Fi, long-range wireless networks) may also be utilized in place of or in combination with such 3GPP carrier networks.

In some examples, the edge cloud 110 may form a portion of or otherwise provide an ingress point into or across a fog networking configuration 926 (e.g., a network of fog devices 924, not shown in detail), which may be embodied as a system-level horizontal and distributed architecture that distributes resources and services to perform a specific function. For instance, a coordinated and distributed network of fog devices 924 may perform computing, storage, control, or networking aspects in the context of an IoT system arrangement. Other networked, aggregated, and distributed functions may exist in the edge cloud 110 between the cloud data center layer 950 and the client endpoints (e.g., client computing nodes 902). Some of these are discussed in the following sections in the context of network functions or service virtualization, including the use of virtual edges and virtual services which are orchestrated for multiple stakeholders.

The edge gateway nodes 912 and the edge aggregation nodes 922 cooperate to provide various edge services and security to the client computing nodes 902. Furthermore, because each client computing node 902 may be stationary or mobile, each edge gateway node 912 may cooperate with other edge gateway devices to propagate presently provided edge services and security as the corresponding client computing node 902 moves about a region. To do so, each of the edge gateway nodes 912 and/or edge aggregation nodes 922 may support multiple tenancy and multiple stakeholder configurations, in which services from (or hosted for) multiple service providers and multiple consumers may be supported and coordinated across a single or multiple compute devices.

### F. Use Case: Satellite Edge Connectivity

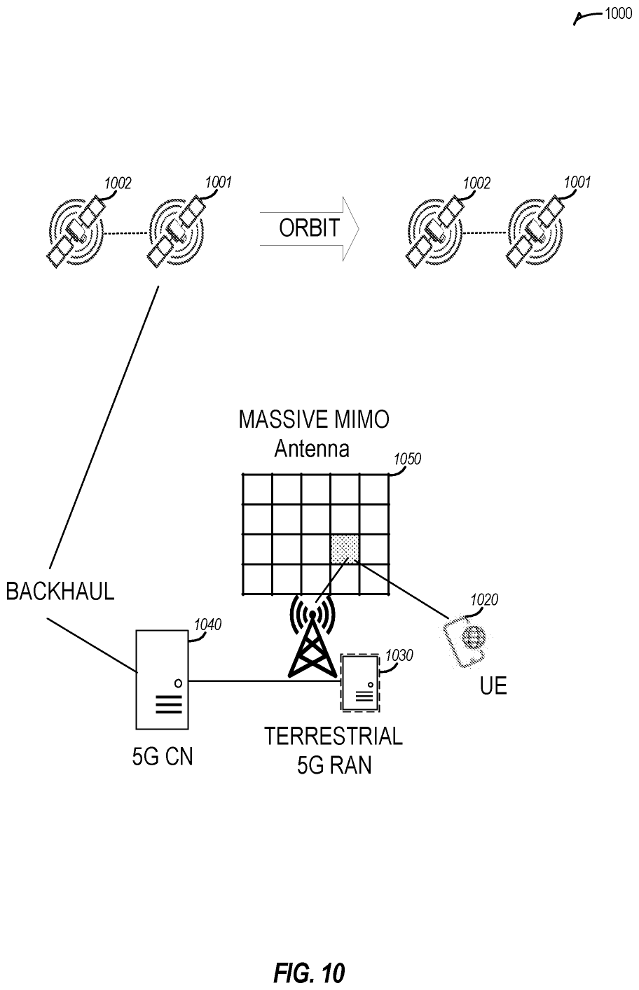

FIG. 10 illustrates network connectivity in non-terrestrial (satellite) and terrestrial (mobile cellular network) settings, according to an example. As shown, a satellite constellation may include multiple satellites 1001, 1002, which are connected to each other and to one or more terrestrial networks. Specifically, the satellite constellation is connected to a backhaul network, which is in turn connected to a 5G core network 1040. The 5G core network is used to support 5G communication operations at the satellite network and at a terrestrial 5G radio access network (RAN) 1030. The RAN may be compatible with O-RAN specifications, in certain embodiments.

FIG. 10 also depicts the use of the terrestrial 5G RAN 1030, to provide radio connectivity to a user equipment (UE) 1020 via a massive MIMO antenna 1050. It will be understood that a variety of network communication components and units are not depicted in FIG. 10 for purposes of simplicity. With these basic entities in mind, the following techniques describe ways in which terrestrial and satellite networks can be extended for various edge computing scenarios.

### G. Software Distribution:

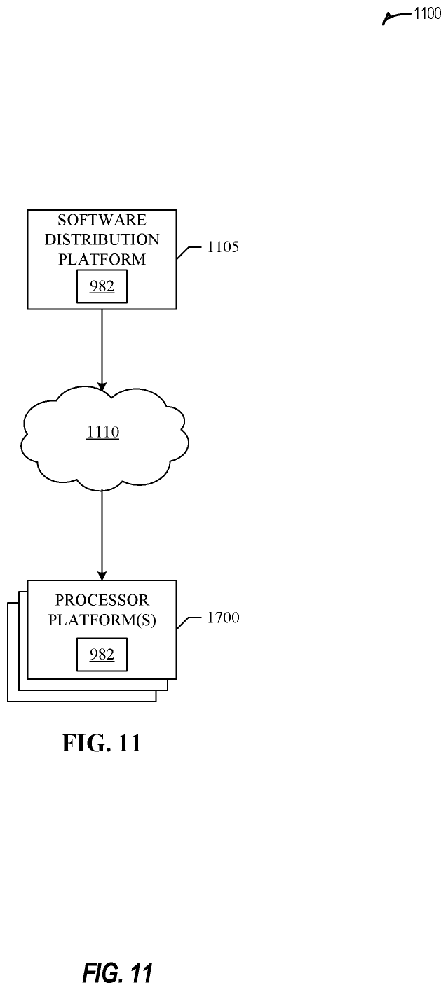

FIG. 11 illustrates an example software distribution platform 1105 to distribute software, such as the example computer readable instructions 882 of FIG. 8, to one or more devices, such as example processor platform(s) 1100 and/or example connected edge devices 862. The example software distribution platform 1105 may be implemented by any computer server, data facility, cloud service, etc., capable of storing and transmitting software to other computing devices (e.g., third parties, the example connected edge devices 862 of FIG. 8). Example connected edge devices may be customers, clients, managing devices (e.g., servers), third parties (e.g., customers of an entity owning and/or operating the software distribution platform 1105). Example connected edge devices may operate in commercial and/or home automation environments. In some examples, a third party is a developer, a seller, and/or a licensor of software such as the example computer readable instructions 882 of FIG. 8. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 11, the software distribution platform 1105 includes one or more servers and one or more storage devices. The storage devices store the computer readable instructions 882. The one or more servers of the example software distribution platform 1105 are in communication with a network 1110, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 882 from the software distribution platform 1105. For example, the software, which may correspond to the example computer readable instructions 882 of FIG. 8, may be downloaded to the example processor platform(s) 1100 (e.g., example connected edge devices), which is/are to execute the computer readable instructions 882 to implement the software instructions. In some examples, one or more servers of the software distribution platform 1105 are communicatively connected to one or more security domains and/or security devices through which requests and transmissions of the example computer readable instructions 882 must pass. In some examples, one or more servers of the software distribution platform 1105 periodically offer, transmit, and/or force updates to the software (e.g., the example computer readable instructions 882 of FIG. 8) to ensure improvements, patches, updates, etc. are distributed and applied to the software at the end user devices.

In the illustrated example of FIG. 11, the computer readable instructions 882 are stored on storage devices of the software distribution platform 1105 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 882 stored in the software distribution platform 1105 are in a first format when transmitted to the example processor platform(s) 1100. In some examples, the first format is an executable binary in which particular types of the processor platform(s) 1100 can execute. However, in some examples, the first format is uncompiled code that requires one or more preparation tasks to transform the first format to a second format to enable execution on the example processor platform(s) 1100. For instance, the receiving processor platform(s) 1100 may need to compile the computer readable instructions 882 in the first format to generate executable code in a second format that is capable of being executed on the processor platform(s) 1100. In still other examples, the first format is interpreted code that, upon reaching the processor platform(s) 1100, is interpreted by an interpreter to facilitate execution of instructions.

### H. Machine Learning in Edge Computing Networks

Machine learning (ML) involves computer systems using algorithms and/or statistical models to perform specific task(s) without using explicit instructions, but instead relying on patterns and inferences. ML algorithms build mathematical model(s) (referred to as “ML models” or the like) based on sample data (referred to as “training data” or the like) in order to make predictions or decisions without being explicitly programmed to perform such tasks. ML algorithms perform a training process on a relatively large dataset to estimate an underlying ML model. Generally, an ML algorithm may refer to a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure. In some cases, an ML model may include an artificial neural network (NN), which is based on a collection of connected nodes (“neurons”) and each connection (“edges”) transmit information (a “signal”) from one node to other nodes. A neuron that receives a signal processes the signal using an activation function and then signals other neurons based on the processing. Neurons and edges typically have weights that adjust as learning proceeds. The weights may increase or decrease the strength of a signal at a connection.

Linear regression is one type of supervised ML algorithm that is used for classification, stock market analysis, weather prediction, and the like. Gradient descent (GD) algorithms may be used in linear regression. Given a function defined by a set of parameters, a GD algorithm starts with an initial set of parameter values, and iteratively moves toward a set of parameter values that minimize the function. This iterative minimization is achieved by taking steps in the negative direction of the function gradient. In some GD implementations, a model is updated iteratively, where multiplication of large matrices and vectors is performed in each epoch. An epoch may refer to a round of machine learning that is performed in the iterative process of updating a model. Since the training phase for GD algorithms may involve a large amount of iterative computations, running GD algorithms can be computationally intensive. Additionally, computation time bottlenecks rapidly as the model order grows in size.

Distributed computing has been used to reduce training time by offloading GD computations to multiple secondary computing nodes. However, distributing GD computations to heterogeneous computing environments, such as those comprising multiple client or edge devices is difficult because, in most cases, the available edge devices have different configurations, capabilities, and operate under different conditions. Additionally, many of the edge devices communicate using wireless links, which have lower reliability (i.e., in terms of link quality and achievable data rates) when compared to wired links used in server farms. The heterogeneous nature of these computing environments may result in longer lag times at each round of training (or “epoch”) due to slower computing devices and/or computing devices with low quality radio links. For these reasons, the conventional distributed ML training approach cannot be straightforwardly applied to heterogeneous computing environments. Recently, federated learning has been proposed for distributed GD computation, where learning takes place by a federation of client computing nodes (which may also be referred to herein as “client devices”) that are coordinated by a central server (which may be referred to herein as a MEC server or controller node).

Federated learning, where a global model is trained with coordination with a federation of client computing nodes/client nodes/clients while keeping the training data local at the clients is one of the problems under consideration herein. The federated learning protocol iteratively allows clients to download a centrally trained artificial intelligence/machine-learning model (or model) from a server, such as a MEC server, an edge server or a cloud server, update it with their own data and upload the model updates (such as a gradient update) back to the server. The model updates may include updates weight values for nodes of the NN model, for instance. The server then aggregates updates from multiple clients to update the global model. Federated learning over wireless edge networks is highly desired since data can be maintained local at the clients while the edge server can utilize the compute capabilities of clients to speed up training.

In federated learning, training may be performed via a supervised machine learning problem (e.g., a GD algorithm) based on a dataset {(Xₖ,yₖ)}_{k=1, . . . , m} to learn underlying model parameters βϵR^{d}, wherein Xₖ is the total training data, k is a number of data points (or training symbols) in Xₖ where k=k to m, and yₖ is an associated model level related to each of the data in Xₖ (e.g., where the underlying model is a single or multi-level model). Each training label is a row vector of training symbols Xₖ=[x_{k,1}, . . . , x_{k,d}]ϵR^{1×d}, and yₖϵR is an associated scalar measurement. Under a linear model, the training data can be represented by Equation (A0).

Y=Xβ+n (A0)

In Equation (A0), is the model to be created, X is the input data, and Y is/are the output variables. In addition, for Equation (A0),

$$X {=}^{△} ( \begin{matrix}\begin{matrix}{X}_{1} \\ ⋮\end{matrix} \\ {X}_{m}\end{matrix} )$$

is an m×d training symbol matrix,

$$β {=}^{△} ( \begin{matrix}\begin{matrix}{β}_{1} \\ ⋮\end{matrix} \\ {β}_{d}\end{matrix} )$$

is a d×1 unknown model parameter matrix,

$$n {=}^{△} ( \begin{matrix}\begin{matrix}{n}_{1} \\ ⋮\end{matrix} \\ {n}_{m}\end{matrix} )$$

is an m×1 measurement noise (e.g., Gaussian) matrix, and

$$Y {=}^{△} ( \begin{matrix}\begin{matrix}{y}_{1} \\ ⋮\end{matrix} \\ {y}_{m}\end{matrix} )$$

is an m×1 measurement vector collected for training.

GD is an optimization algorithm used to minimize a target function by iteratively moving in the direction of a steepest descent as defined by a negative of the gradient. An objective of GD in ML is to utilize a training dataset D in order to accurately estimate the unknown model β over one or more epochs r. In ML, GD is used to update the parameters of the unknown model β. Parameters refer to coefficients in linear regression and weights in an NN. These objectives are realized in an iterative fashion by computing β^{(r)} at the r-th epoch, and evaluating a gradient associated with the squared-error cost function defined by f(β^{(r)})=∥Xβ^{(r)}−Y∥². The cost function indicates how accurate the model β is at making predictions for a given set of parameters. The cost function has a corresponding curve and corresponding gradients, where the slope of the cost function curve indicates how the parameters should be changed to make the model β more accurate. In other words, the model β is used to make predictions, and the cost function is used to update the parameters for the model β. The gradient of the aforementioned squared-error cost function is given by Equation (A1), and β^{(r)} is updated at each epoch r according to Equation (A2).

$${∇}_{β} f ( {β}^{( r )} ) = {X}^{′} ( X {β}^{( r )} - Y ) \qquad ( A1 )$$

$${β}^{( r + 1 )} = {β}^{( r )} - \frac{μ}{m} {∇}_{β} f ( {β}^{( r )} ) \qquad ( A2 )$$

In Equation (A2), m is the total number of observations (i.e., data points), μ is a learning rate (also referred to as an update parameter or step size) for moving down a particular gradient, where)<μ≤1, and ∇_{β}f(β^{(r)}) is a prediction based on the model β^{(r)}. GD involves computing Equations (A1) and (A2) in tandem until the model parameters converge sufficiently. The gradient in Equation (A1) involves multiplications involving matrices and vectors of large sizes. Therefore, GD becomes computationally prohibitive as dataset and model parameters become massive.

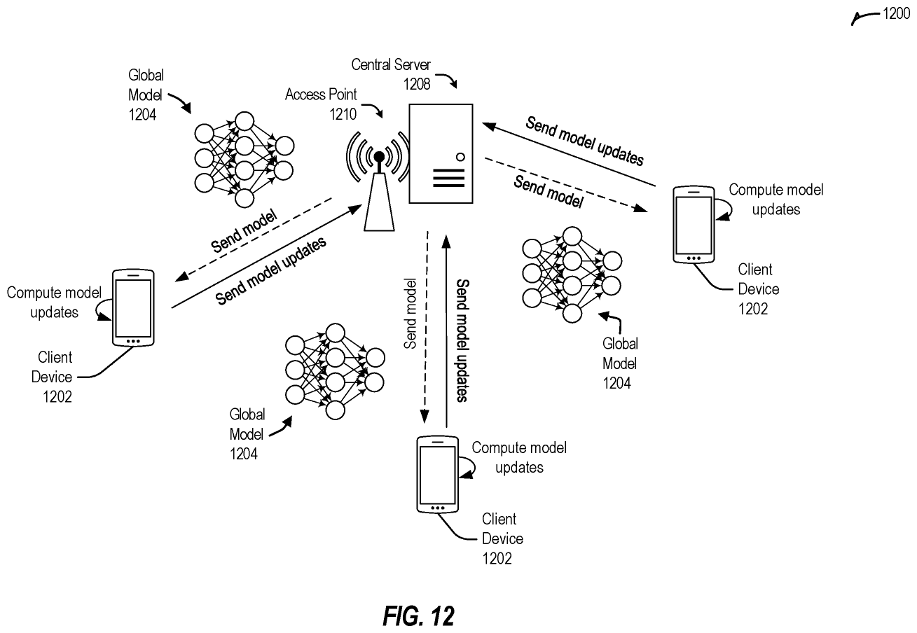

In order to meet computation demand of Equation (A1), edge computing nodes can locally compute partial gradients from their respective local data sets and communicate the computed partial gradients back to a central node for aggregation. FIG. 12 depicts an example of federated learning in an edge computing environment 1200. In the example shown, each client computing node 1202 fetches or otherwise obtains a global model 1204 from a central server 1208 (e.g., a MEC server) coupled to an access point 1210 (e.g., a base station), updates aspects of the global model (e.g., model parameters or weights used in the global model, e.g., NN node weights) using its local data or data provided by the central server (e.g., a subset of a large training dataset D), and communicates the updates to the global model to the central server 1208. The central server 1208 then aggregates (e.g., averages) the received updates and obtains a final global model based on the aggregated updates (e.g., updates the model weight values based on an average of the weight values received from the clients). Federated learning may be more efficient than asynchronous update methods as it avoids the prohibitive number of model updates both at the central server and worker computing nodes.

Model updates or updates to a global model, as described herein, may include a set of values that are used to construct the global model. For example, where the global model is a NN model, a client or server may perform machine learning to obtain updated values for various nodes of the NN. The values may be aggregated by a node, e.g., averaged by the server, and the aggregated node weight values may be used for future implementations of the NN.

A central server as described herein may refer to an edge compute node that acts as a server to other edge compute notes of an edge computing environment. In some embodiments, functions or operations described herein as being performed by a central server may be performed by multiple servers. For instance, some example embodiments described herein include clients providing capability data, model updates or other parameters to a central server, but such capability data, model updates, or parameters may be provided by the clients to different central servers. The central server(s) may be structurally formed as described further herein. For instance, the central server(s) may be configured to fit within a unit of a server rack (e.g., a 1U or multiple unit rack device), or may be configured to fit within a sled. In some instances, the central server as described herein may be implemented as a “MEC server”. However, it is to be understood that any type of server, such as an edge server, a cloud server, an on-premise server, etc. may be used in the alternative. A server, e.g., a MEC server, as described herein may be constructed to fit within any of the structural embodiments described herein. For example, a server such as a MEC server may be configured fit within a server rack or sled, e.g., as described in greater detail herein.

Further, a client (or client compute node) as described herein may refer to an edge compute node that is served, controlled, or otherwise commanded by one or more other edge compute nodes (e.g., central server(s) as described above). For instance, as described herein, the clients perform machine learning based on information and/or commands from another node(s) (i.e., a central server(s)). A client device may include a server device, such as a device structurally configured as described herein (e.g., to fit within a server rack or sled), a mobile computing device (e.g., tablet, smartphone, etc.), or may include another type of computing device.

With this technique, Equation (A1) can be decomposed into m partial sums as shown by Equation (A3).

$${∇}_{β} f ( {β}^{( r )} ) = {\sum }_{k = 1}^{m} {X}_{k}^{′} ( {X}_{k} {β}^{( r )} - {y}_{k} ) \qquad ( A3 )$$

More particularly, the training dataset X⁽ⁱ⁾ and the associated label vector y⁽ⁱ⁾ for the i-th device may be given by

$${X}^{( i )} = [ \begin{matrix}\begin{matrix}{X}_{1}^{( i )} \\ ⋮\end{matrix} \\ {X}_{{l}_{i}^{initial}}^{( i )}\end{matrix} ] , and {y}^{( i )} = [ \begin{matrix}\begin{matrix}{y}_{1}^{( i )} \\ ⋮\end{matrix} \\ {y}_{{l}_{i}^{initial}}^{( i )}\end{matrix} ] ,$$

where lᵢ^{initial} is the number of training data points available at the i-th device. Note that the dimension of X⁽ⁱ⁾ is lᵢ^{initial}×d, where d is the dimension of feature space. Each device may locally compute partial gradients in each epoch, say the r-th epoch, such as by

$${∇}_{β} {f}_{i} ( {β}^{( r )} ) = {\sum }_{k = 1}^{{l}_{i}^{initial}} {X}_{k}^{{( i )}^{′}} ( {X}_{k}^{( i )} {β}^{( r )} - {y}_{k}^{( i )} ) , \qquad ( A4 )$$

where β^{(r)} is the estimate of the global model. The partial gradient is communicated to the central node for aggregation, and the global gradient may be given by

$${∇}_{β} f ( {β}^{( r )} ) = {\sum }_{i = 1}^{n} {∇}_{β} {f}_{i} ( {β}^{( r )} ) . \qquad ( A5 )$$

The model may be updated by the central server as

$${β}^{( r + 1 )} = {β}^{( r )} - \frac{μ}{m} {∇}_{β} f ( {β}^{( r )} ) , \qquad ( A6 )$$

where m=Σᵢ₌ᵢⁿ lᵢ^{initial} is the totality of training data points and μ is the learning rate.

In the following sections, a “client compute/computing node” or “client node” or “client” may refer to any edge computing node that is to train a model with the data available to it, such as data that the client computing node may wish to keep private.

According to some embodiments, a message or communication between a first edge computing node and a second edge computing note, or between a client computing node and a central server, may be transmitted/received on an application programming interface (API), embedded in L1/L2/L3 layers of the protocol stack depending on the application, on a Physical (PHY) layer, or on a Medium Access Control (MAC) layer as set forth in wireless standards, such as the 802.11 family of standards, or the Third Generation Partnership Project (3GPP) Long Term Evolution (LTE) or New Radio (NR or 5G) family of technical specifications, by way of example only. The message or communication, according to some embodiments, may involve a parameter exchange to allow an estimation of wireless spectrum efficiency, and in such a case it may be transmitted/received on a L1 layer of a protocol stack. The message or communication, according to some embodiments, may involve a prediction of edge computing node sleep patterns, and in such a case it may be transmitted/received on a L2 layer of a protocol stack. The message or communication, according to some embodiments, may be transmitted or received on a transport network layer, an Internet Protocol (IP) transport layer, a General Radio Packet Service Tunneling Protocol User Plane (GTP-U) layer, a User Datagram Protocol (UDP) layer, an IP layer, on a layer of a control plane protocol stack (e.g. NAS, RRC, PDCP, RLC, MAC, and PHY), on a layer of a user plane protocol stack (e.g. SDAP, PDCP, RLC, MAC, and PHY).

I. Distributed Meta-Learning for Federated Learning with Non-IID Data

Meta-learning may refer to an ensemble of approaches that focus on efficiently learning new tasks/skills. This may include approaches that focus on achieving an efficient weight initialization that can allow learning new tasks using a small amount of data easy. Other meta-learning approaches may focus on learning hyper-parameters of the training algorithm. The present disclosure includes consideration of a distributed implementation of a meta-learning approach, which may: (1) facilitate distributed learning where a global model needs to be trained from a fleet of clients without sharing data between each other; and/or (2) better address the problem of efficiently learning a common model when different devices have data that is not independent and identically distributed (non-I.I.D). Certain strategies are proposed below to reduce the total training time of a meta-learning approach through communication efficient strategies.

For instance, certain embodiments of the present disclosure may utilize a modified objective to federated learning where the goal is not necessarily to minimize the empirical risk across the overall population of data across all the devices. Instead, the modified objective may be to minimize the expected empirical risk over the clients that will have one or more local gradient updates from the final trained model. The new objective may allow for learning of a model that is a certain condition number away for each client, given that the clients are able to perform a further one or more steps of local training after the final global model is trained. In particular embodiments, key contributions to achieving the modified objective may include distributed/federated approaches to perform model-agnostic meta learning across a fleet of client devices with different computational and communication overheads.

Previous federated learning problems aim to learn a global model w across a fleet of clients each with their own datasets and local loss functions Fₖ(w) such that

$${min}_{w} f ( w ) = {min}_{w} {E}_{p} [ {F}_{k} ( w ) ] = {min}_{w} \frac{1}{{\sum }_{k = 1}^{N} {n}_{k}} {\sum }_{k = 1}^{N} {n}_{k} {F}_{k} ( w ) , \qquad ( B1 )$$

where p indicates a distribution of number of data across clients.

The goal of the above approach is to learn a model that will minimize the weighted average of the empirical risk across the different clients. The solution of above problem is given by each client computing a gradient estimate on their local loss function computed from their data, e.g., according to:

$${g}_{k} = \frac{1}{{n}_{k}} {\sum }_{i}^{{n}_{k}} {∇}_{w} L ( x , y ; w ) ; ∀ k ∈ K ,$$

where the local weights are updated from the initial global weight at each iteration, e.g., according to:

wₜ₊₁^{k}=wₜ−ηgₖ,

With the central server then combining (e.g., averaging) the weights from all clients, e.g., according to:

$${w}_{t + 1} = \frac{1}{{\sum }_{k}^{K} {n}_{k}} {\sum }_{k}^{K} {n}_{k} {w}_{t + 1}^{k} .$$

This approach may have several challenges, including, for example, the statistical heterogeneity of the different clients, which can lead to divergence of the model. In other words, the federated averaging approach above assumes that gradient computations from each client is an unbiased estimate of the true gradient of the overall data population.

In aspects of the present disclosure, however, meta-learning may be applied in a federated learning setup to solve the following problem instead:

min_{w}Eₚ[Fₖ(w−β∇Fₖ(w))], (B2)

That is, the goal of the learning in embodiments herein may be to obtain a model that, on an average, will be one or a few gradient steps with learning rate β away for each of the clients. This can provide a higher level of performance guarantee of the global model towards the individual clients. By learning an “initializer model” according to the techniques herein, the initializer model may be able to learn across the multiple devices, but then allow the devices to further learn locally using fewer iterations.

In certain aspects of the present disclosure, the problem in Equation (B2) is treated as a distributed learning framework where a set of clients are learning a global model with the assistance of a central server (e.g., MEC server) that will satisfy the condition in Equation (B2) and develop efficient methods to achieve the same.

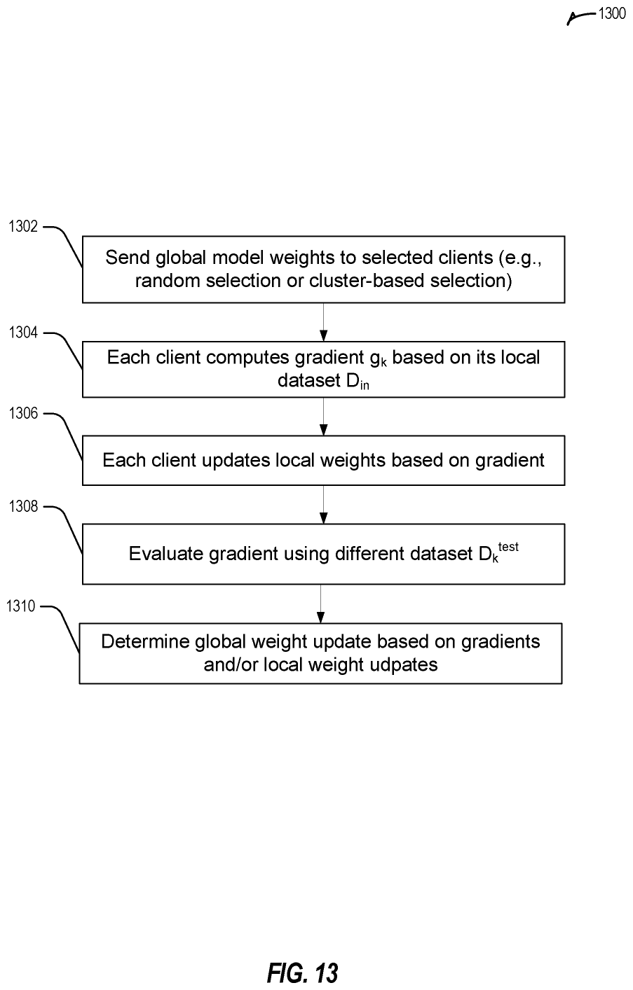

FIG. 13 illustrates a flow diagram of an example process 1300 for performing federated meta-learning. The example process may be implemented in software, firmware, hardware, or a combination thereof. For example, in some embodiments, operations in the example process shown may be performed by one or more components of an edge computing node, such as processor(s) of a client device similar to client computing nodes 1202 of FIG. 12 or processor(s) central server similar to central server 1208 of FIG. 12. In some embodiments, one or more computer-readable media may be encoded with instructions that implement one or more of the operations in the example process below when executed by a machine (e.g., a processor of a computing node). The example process may include additional or different operations, and the operations may be performed in the order shown or in another order. In some cases, one or more of the operations shown in FIG. 13 are implemented as processes that include multiple operations, sub-processes, or other types of routines. In some cases, operations can be combined, performed in another order, performed in parallel, iterated, or otherwise repeated or performed another manner.

In the example shown, at 1302, global model weights (e.g., weights for model 1204 of FIG. 12) are sent by a central server (e.g., 1208 of FIG. 12) to a selected set of clients (e.g., 1202 of FIG. 12). The clients may be selected by the central server in any suitable way. For example, in some instances, K clients may be selected randomly from N total clients. As another example, the clients may be clustered (by the central server or by another edge compute node), and clients may be selected from the clusters. Example clustering approaches are described further below.

At 1304, each client computes a local gradient gₖ based on its own dataset Din. The gradient may be a local stochastic gradient that is computed based on the global model weights. In certain embodiments, a Hessian hₖ on gₖ may also be determined by the client at 1304. The gradient gₖ may be considered as a first derivative of the update, while the Hessian hₖ may be considered as a second derivative of the update.

At 1306, each client updates its local weights updates based on the gradient computed at 1304. In certain instances, the local weight updates may be updated via a parameterized local weight update based on the gradient gₖ. Examples are described further below.

At 1308, the gradient computed at 1304 is evaluated using a different dataset Dₖ^{test}. In some cases, the gradient evaluation may be performed locally by each client, while in other cases, the gradient evaluation may be performed by the central server. The gradient evaluation allows for the meta-learning of the present disclosure.

Finally, at 1310, a global weight update is determined based on the computed gradients and/or local weight updates. Detailed example approaches to performing federated meta-learning are described below.

Approach 1: Federated Meta Averaging

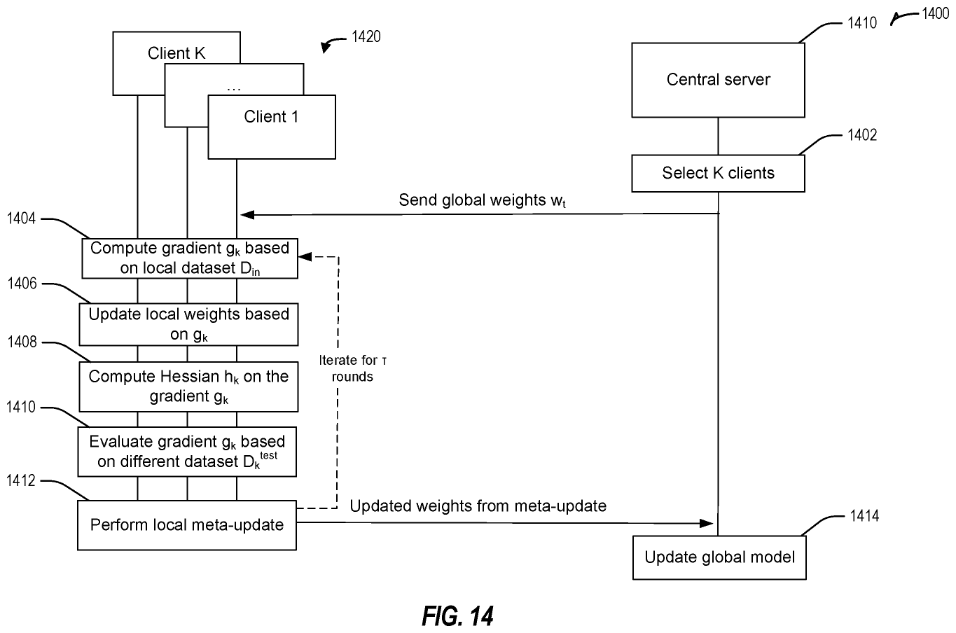

FIG. 14 illustrates a flow diagram of another example process 1400 for performing federated meta-learning. The example process may be implemented in software, firmware, hardware, or a combination thereof. For example, in some embodiments, operations in the example process shown may be performed by one or more components of an edge computing node, such as processor(s) of client devices 1420 (which may be similar to client computing nodes 1202 of FIG. 12) or processor(s) of central server 1410 (which may be similar to central server 1208 of FIG. 12). In some embodiments, one or more computer-readable media may be encoded with instructions that implement one or more of the operations in the example process below when executed by a machine (e.g., a processor of a computing node). The example process may include additional or different operations, and the operations may be performed in the order shown or in another order. In some cases, one or more of the operations shown in FIG. 14 are implemented as processes that include multiple operations, sub-processes, or other types of routines. In some cases, operations can be combined, performed in another order, performed in parallel, iterated, or otherwise repeated or performed another manner.

In the example shown, at 1402, the central server selects a set of K clients from a number N clients. In some instances, the central server draws the set K of clients uniformly from the distribution p of N clients, where each client has its own underlying data distribution qₖ and the data (x,y) represent a d-dimensional training data and label respectively. In other instances, the central server selects the K clients based on the clustering approach described further below. The central server sends global model weights wₜ to the selected K clients.

At 1404, each client computes a gradient gₖ, e.g., by performing a local stochastic gradient update, based on its local dataset Dᵢₙ (i.e., (x, y) in the equation below, which may include the training dataset x and associated labels y as described in Section H above.). The gradient may be computed according to:

$${g}_{k} = \frac{1}{{n}_{k}} {\sum }_{i}^{{n}_{k}} {∇}_{w} L ( x , y ; w ) ; ∀ k ∈ K .$$

At 1406, each client updates its local weights based on the gradient computed at 1404. The local weight updates may be computed according to:

w̅ₜ₊₁^{k}=wₜ−βgₖ.

where β represents a step size for the learning process.

At 1408, each client computes a Hessian hₖ on the gradient gₖ computed at 1404. The Hessian may be computed on the local dataset Dᵢₙ, or in some instances, may be computed on a separate dataset, as long as the separate dataset is i.i.d. drawn from qₖ.

At 1410, each client k evaluates the gradient expression for the ML model computed at 1404 at the local weights computed 1406 (i.e., w̅ₜ₊₁^{k}) as gₖ(w̅ₜ₊₁^{k}) based on a different dataset Dₖ^{test}. Evaluating the gradient expression may refer to determining a value of gₖ from the equation above using different data inputs, i.e., Dₖ^{test} instead of Dᵢₙ in this example. The separate test dataset Dₖ^{test} may be stored at the client and may be drawn i.i.d from qₖ.

At 1412, each client computes (I−βhₖ)gₖ(w̅ₜ₊₁^{k}) and performs a local meta update, e.g., according to:

wₜ₊₁^{k}=wₜ−α*(I−βhₖ)gₖ(w̅ₜ₊₁^{k}),

where α represents a learning rate for this meta update step and I represents an identity matrix. In some embodiments, the clients can also perform τ local update steps as they obtain the new local meta model as w_{t+τ}^{k}. That is, the operations of 1404-1412 may be performed iteratively for τ rounds locally at each client. The client then sends w_{t+τ}^{k} to the central server, which performs a global model update at 1414 according to:

$${w}_{t + 1} = \frac{1}{{\sum }_{k}^{K} {n}_{k}} {\sum }_{k}^{K} {n}_{k} {w}_{t + τ}^{k}$$

The operations of the example process 1400 may be repeated iteratively until convergence is achieved. Convergence may be defined as (wₜ₊₁−wₜ) being below a particular threshold.

Approach 2: Federated Meta Stochastic Gradient Descent (SGD)

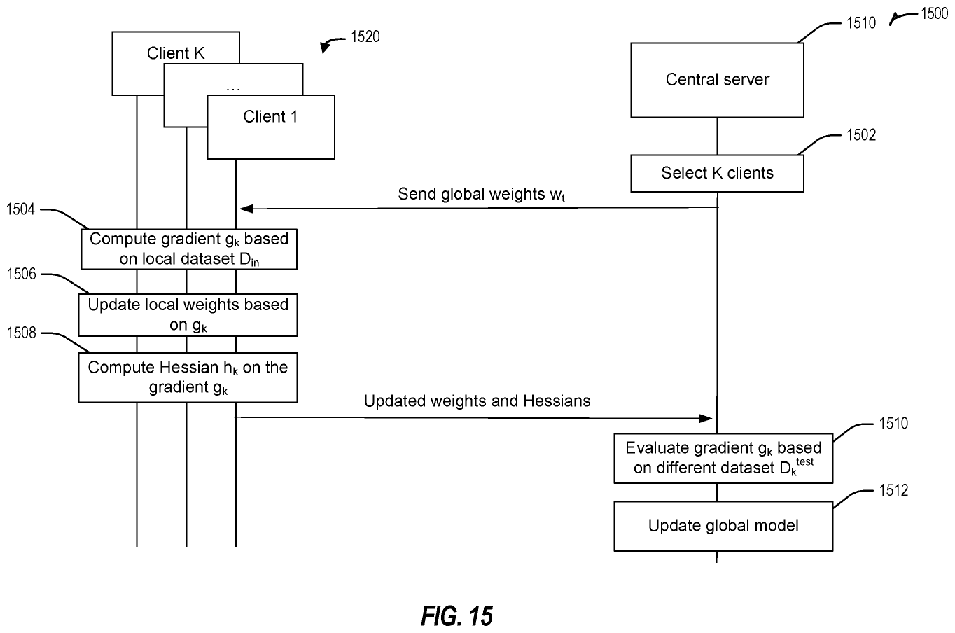

FIG. 15 illustrates a flow diagram of another example process 1500 for performing federated meta-learning. The example process may be implemented in software, firmware, hardware, or a combination thereof. For example, in some embodiments, operations in the example process shown may be performed by one or more components of an edge computing node, such as processor(s) of client devices 1420 (which may be similar to client computing nodes 1202 of FIG. 12) or processor(s) of central server 1410 (which may be similar to central server 1208 of FIG. 12). In some embodiments, one or more computer-readable media may be encoded with instructions that implement one or more of the operations in the example process below when executed by a machine (e.g., a processor of a computing node). The example process may include additional or different operations, and the operations may be performed in the order shown or in another order. In some cases, one or more of the operations shown in FIG. 15 are implemented as processes that include multiple operations, sub-processes, or other types of routines. In some cases, operations can be combined, performed in another order, performed in parallel, iterated, or otherwise repeated or performed another manner.

At 1502, the central server selects a set of K clients from a number N clients. In some instances, the central server draws the set K of clients uniformly from the distribution p of N clients, where each client has its own underlying data distribution qₖ and the data (x,y) represent a d-dimensional training data and label respectively. In other instances, the central server selects the K clients based on the clustering approach described further below. The central server sends global model weights wₜ to the selected K clients.

At 1504, each client performs a local stochastic gradient update based on its local dataset Dᵢₙ. The gradient may be computed according to:

$${g}_{k} = \frac{1}{{n}_{k}} {\sum }_{i}^{{n}_{k}} {∇}_{w} L ( x , y ; w ) ; ∀ k ∈ K .$$

At 1506, each client updates its local weights based on the gradient computed at 1504. The local weight updates may be computed according to:

w̅ₜ₊₁^{k}=wₜ−βgₖ.

where β represents a step size for the learning process.

At 1508, each client computes its Hessian hₖ on the gradient gₖ computed at 1504. The Hessian may be computed on the local dataset Dᵢₙ, or in some instances, may be computed on a separate dataset, as long as the separate dataset is i.i.d. drawn from qₖ.

At 1510, each of the K clients sends the parameterized weight updates computed at 1506 (w̅ₜ₊₁^{k}) and Hessians computed at 1508 (hₖ) to the central server.

At 1512, the central server utilizes the gradient expression for the ML model and evaluates the gradient at each of the local weight updates as gₖ(ŵₜ₊₁^{k}) using a sample dataset corresponding to each client Dₖ^{test}.

At 1514, the central server performs a global model weight update. The global model weights may be updated using a meta-update process as above, e.g., according to:

$${w}_{t + 1} = {w}_{t} - α \frac{1}{{\sum }_{k}^{K} {n}_{k}} {\sum }_{k}^{K} {n}_{k} ( I - β {h}_{k} ) {g}_{k} ( {\overline{w}}_{t + 1}^{k} ) .$$

The operations of process 1500 may then be repeated iteratively until convergence is achieved. Convergence may be defined as (wₜ₊₁−wₜ) being below a particular threshold.

As described above, each of the selected client devices will send weight updates w̅ₜ₊₁^{k} and Hessians hₖ to the central server, whereas in federated learning without meta-learning approaches, the Hessian component may not be computed or transmitted to the central server. Thus, transmission of the Hessian component from a client to central server may indicate an application of a distributed meta-learning approach such as Approach 2.

The two different approaches described above can result in different overheads in terms of computing and communication. For example, Approaches 1 and 2 described above are compared in Table 1 below.

TABLE 1
Overhead Comparison Between Approach 1 and Approach 2

| | Approach 1 | Approach 2 |
|---|---|---|
| Local Gradient computation | Yes | Yes |
| Local weight update step | Yes | Yes |
| Local Hessian computation | Yes | Yes |
| Local Gradient Evaluation | Yes | No |
| Upload local gradient and | No | Yes |
| Hessian | | |
| Allow multiple local | Yes | No |
| updates | | |

Meta-Learning Over Client Data Distributions of Interest

In certain instances, instead of minimizing the expectation over the clients in Equation (B2) above, it is also possible to minimize the expectation over a distribution of tasks that the central server is interested in, i.e., p is the distribution over the tasks of interest. The tasks can be a set of unique data distributions in the network. In such a case, the clients can be clustered according to their data distributions qi, each cluster then belongs to a specific task. Heuristic approaches or even an unsupervised learning algorithm (such as K-means clustering) could be utilized to cluster the clients into tasks. This will require clients to share.

Clustering Approaches

In an initialization phase of a clustering approach, each client may transmit probability distribution information, e.g., a histogram of its data, to the central server. A client could use a subset of data samples, in some instances. The central server then normalizes the histogram and clusters the clients having similar distributions/normalized histograms. There are many approaches possible for the clustering algorithm, but some example clustering algorithms include Bregman's k-means clustering and affinity propagation clustering.

With Bregman's k-means clustering, the normalized histograms are clustered using an algorithm for some k using a Bregman's divergence metric. One example of a Bregman's metric is KL divergence. The value k is optimized for some performance metric.

With affinity propagation, a similarity metric is used to cluster the clients. For instance, let hᵢ and hⱼ be the denote the histograms transmitted by clients i and j. A pairwise similarity metric sᵢⱼ between i and j may be used, e.g., where sᵢⱼ is denoted by −0.5(d(hᵢ, hⱼ)+d(hⱼ, hᵢ)), where d is some distance metric between distributions. Some examples for the distance metric d include: KL divergence, Wasserstein metric, Bhattacharyya distance etc. The set {sᵢⱼ} is used as the similarity matrix for affinity propagation. Note that this approach has the potential advantage that the number of clusters does not have to be specified a priori.

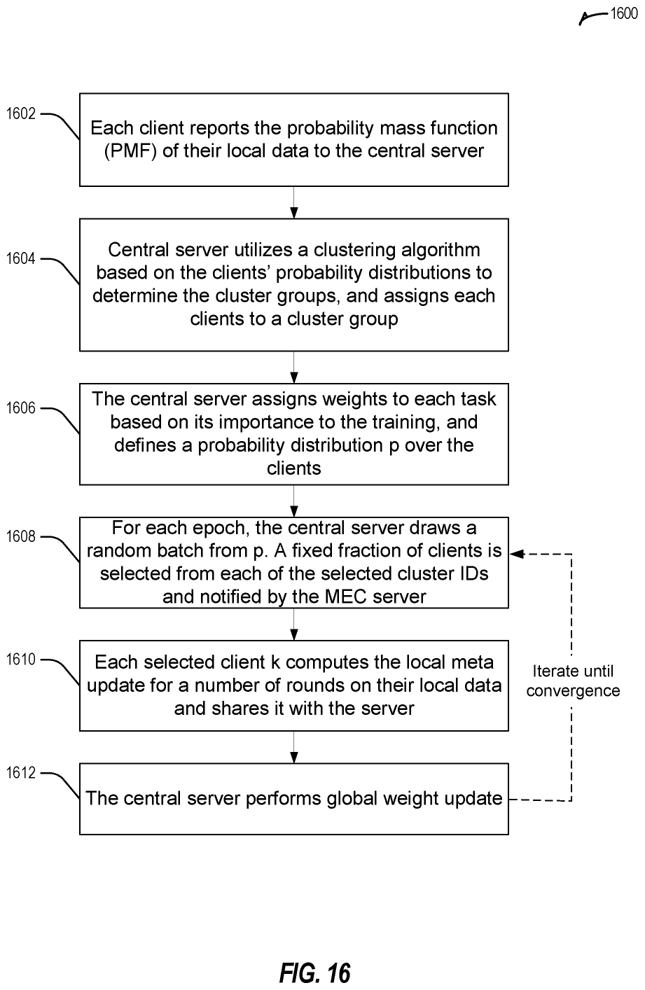

FIG. 16 illustrates a flow diagram of another example process 1600 for performing federated meta-learning. The example process may be implemented in software, firmware, hardware, or a combination thereof. For example, in some embodiments, operations in the example process shown may be performed by one or more components of an edge computing node, such as processor(s) of a central server similar to central server 1208 of FIG. 12. In some embodiments, one or more computer-readable media may be encoded with instructions that implement one or more of the operations in the example process below when executed by a machine (e.g., a processor of a computing node). The example process may include additional or different operations, and the operations may be performed in the order shown or in another order. In some cases, one or more of the operations shown in FIG. 16 are implemented as processes that include multiple operations, sub-processes, or other types of routines. In some cases, operations can be combined, performed in another order, performed in parallel, iterated, or otherwise repeated or performed another manner.

At 1602, each client reports the probability mass function (PMF) of its local data to the central server. This may include a PMF of the client's training examples (x) or associated labels (y). To reduce the dimensionality of this communication, for supervised learning, in some embodiments, the clients can send the PMF of their data labels yₖ.

At 1604, the central server utilizes a clustering algorithm based on the clients' data probability distributions to determine cluster groups. The clustering may be performed using any suitable algorithm, e.g., those described above. The central server also assigns each client to a cluster group. Each cluster group is identified by its nominal data distribution qi. Thus, clients with similar data distributions are likely to belong to the same cluster.

At 1606, the central server assigns weights to each task based on its importance to the training. A probability distribution p is defined over the clusters. If all cluster groups have equal importance, p can be a discrete uniform distribution over the groups.

At 1608, for each epoch, the central server draws a random batch of cluster(s) from the distribution p. A fixed fraction of clients is then selected from each of the drawn clusters and the selected clients are notified by the central server.

At 1610, each selected client k computes a local meta update, e.g., as described above with respect to Approach 1 according to:

w_{t+τ}^{k}=wₜ−α*(I−βhₖ)gₖ(w̅_{t+τ}^{k})

for τ rounds on their local data. The clients can then share the local meta update with the central server.

At 1612, the central server performs a global weight update, e.g., according to:

$${w}_{t + 1} = {w}_{t} - α \frac{1}{{\sum }_{k}^{K} {n}_{k}} {\sum }_{k}^{K} {n}_{k} {w}_{t + τ}^{k} .$$

The operations of 1608, 1610, and 1612 may be repeated iteratively until convergence is reached. Convergence may be defined as (wₜ₊₁−wₜ) being below a particular threshold.

As described above, each of the selected client devices will send statistical information to the central server, such as probability mass function information or a KL-divergence metric relative to the overall probability distribution. Thus, transmission of such statistical information from clients to the central server may indicate an application of a distributed meta-learning approach such as Approach 3.

By using a clustering algorithm as above, clients may be grouped based on their probability distributions. The requirement of the meta-learning is then to train on I.I.D samples from each of the different clusters. We can then assume that each cluster group contains datasets from clients that are I.I.D samples of distribution qi. This insight allows us to perform client selection that will reduce the overall training time while still sampling the clients from the overall distribution.

In some embodiments, the server may further select clients based on their specific communication and/or compute abilities. For instance, after the central server draws a random batch B of groups from p as described above, only the C clients with the smallest upload time Tₖ^{up} (an amount of time the clients take to compute and upload model updates to the central server) can are sampled from each group. For example, at the beginning of training, each client can report its uplink communication time Tₖ^{comm} (an amount of time to communicate the model update to the central server) and computation time Tₖ^{comp} (an amount of time to compute the model update), and the central server can then compute an upload time Tₖ^{up} (e.g., Tₖ^{comm+} Tₖ^{comp}) for each client, which can be used for client selection within the batches.

Experimental Results

The following illustrates example performances of the different variants of the invention using the Fashion MNIST dataset with a network containing 100 clients. The Fashion MNIST dataset contains 60000 training examples and 10000 test examples. The training and test data are distributed such that each client has only 1 class of data. Therefore, each client has 600 training examples and 100 test examples. A deep neural network (DNN) with 2 hidden layers is utilized, using a learning rate of 0.01 for Gradient and Hessian updates. Once the model is trained, each client is allowed to personalize their model by allowing 1 gradient update on a very small set of examples (e.g., 2 examples).

In particular, the following approaches were tested: (A) a baseline federated averaging algorithm (FedAvg), which represents the federated averaging algorithm as described above with respect to Equation (B1). In this approach, clients were not allowed to perform model updates after achieving the converged model; (B) The FedAvg algorithm described above with respect to Equation (B1), following which each client performs one local update on the model after achieving the converged model (FedAvg+1update); (C) The FedAvg algorithm described above with respect to Equation (B1), following which each client performs 5 local updates on the model achieving the converged model (FedAvg+5updates); (D) Federated Meta learning (FedMAML) algorithm as described above with respect to Equation (B2).

Further, each of the above methods is evaluated using different client selection algorithms that include the following: (i) Random selection: clients are sampled randomly ( ), (ii) Client selection based on clustering as described with respect to Approach 3 above, with one client selected per cluster/group, and (iii) Client selection based on clustering as described with respect to Approach 3 above, with clients selected based on having shortest upload time per their cluster/group.

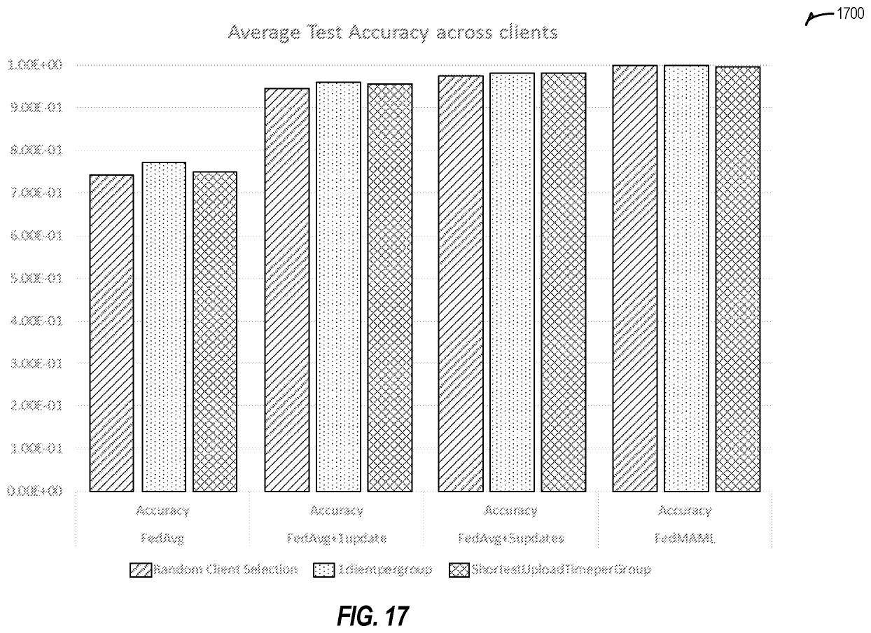

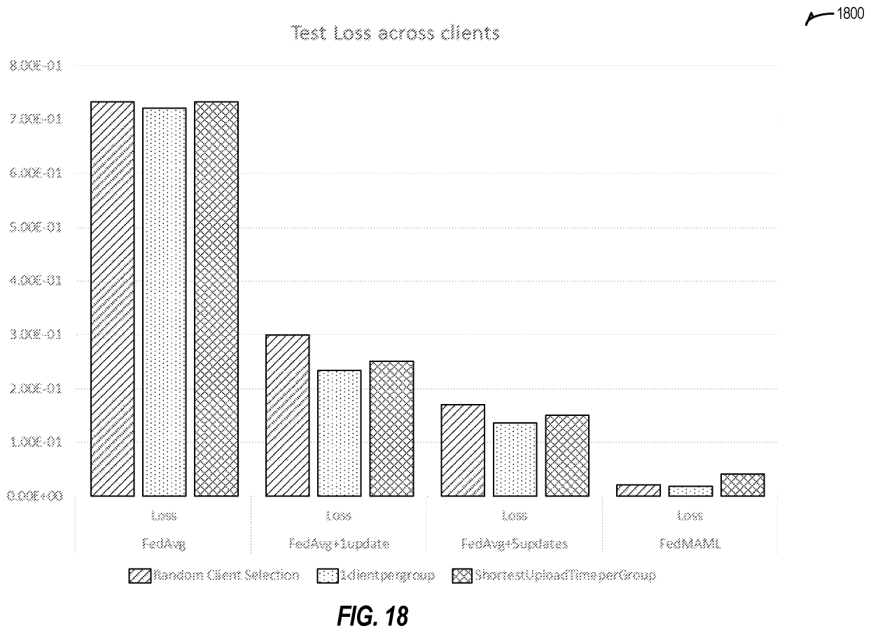

FIGS. 17-18 illustrate the experimental results of different federated meta-learning approaches. In the examples shown, the bars with slanted line shading represent the random selection as per (i) above, the bars with dotted shading represent the client selection as per (ii) above, and the bars with cross-hatch shading represent the client selection as per (iii) above. As shown in the charts 1700 and 1800 of FIGS. 17 and 18, respectively, the FedAvg algorithm (per (A) above) has the lower bound on the test accuracy and test loss performance. When we allow 1 or 5 local updates following FedAvg (as in (B) and (C) above, respectively), the test accuracy is improved from around 75% to around 97%, respectively.

Further, in the examples shown, the Federated meta learning approach (FedMAML) of (D) above has the highest test accuracy and lowest test loss showing good model adaptability to individual clients after training only 1 round on very few (e.g., 2 data points) training examples. It is noted that by utilizing the probability-based grouping and client sampling with the lowest upload time does not have a significant reduction in the performance of all the 4 approaches. It is further noted that the total training time is shown to be reduced by ˜40×, as indicated by the total training times shown in Table 2 below for the random client selection approach (2250 s) and the selection of clients based on a shortest upload time (60 s).

TABLE 2
Total Training Time for FedMAML Approach
for Different Client Selection Techniques

| | FedMAML: | FedMAML: Select |
|---|---|---|
| | Random Client | clients based on |
| | Selection | ShortestUploadTime |
| Total Time | 2250 s | 60 s |

### J. Compute-Aware Batch Size Selection for Federated Learning

In some federated learning embodiments, a central server may select K clients for learning randomly or based on various factors, e.g., communication, compute, and/or other client device abilities. Selecting only the fastest K clients in federated learning can lead to certain issues. For example, when data across clients are not independent and identically distributed (BD), it can lead to model divergence. Also, it can lead to poor model fairness across clients and to class imbalance in training. One aspect that is not considered in current federated learning systems is the heterogeneity of the compute times (i.e., how long it takes for each client device to perform the parameter updates) or the number of training data at the different clients. Since data remains at the clients, different clients may have different amounts of training data. Instead, current systems may simply assume that all clients can compute gradients (through SGD updates) on their entire training dataset and then provide weights to the server. Because of this, the weight computation time can vary widely between clients, leading to unwanted delay in the training process (e.g., a client with a larger dataset may take longer to perform a weight update than a client with a smaller dataset). This delay may be referred to as a straggler problem, where the clients taking longer to perform the update being referred to as stragglers.

In certain embodiments of the present disclosure, however, the selected K clients may perform federated learning operations (e.g., gradient computations) on different data batch sizes such that their job completion times are similar to one another. This may reduce the probability of encountering one or more straggler devices that delay the computation in each round of federated learning. For example, in some embodiments, each client may partition its local training data into batches and train only on one batch at a time to provide weight updates to the server. This may significantly reduce the time taken for each federated training round, speeding up the overall training process without affecting the performance of the training algorithm. That is, the clients may perform gradient descent and weight updates using just a subset of their dataset. The size of each client's subset or “batch” may be based on the time taken to compute an update at that client. By determining different batch sizes for the clients based on their compute abilities, for example, the time taken by each client to perform its gradient computation/weight update may be similar, thereby reducing the overall time taken to achieve convergence. In addition, compute-aware batch size selection may preserve the original objective of federated learning by sampling from all the batches uniformly.

In some instances, a minimum acceptable batch size may be determined by a central server. The minimum batch size may refer to a minimum size of the dataset used by each client to perform an update in a round of federated learning. By carefully constructing the minimum acceptable batch size, a potential pitfall of needing more training rounds for convergence may be avoided. As a result, the overall training time to convergence may be reduced by embodiments of the present disclosure.

To determine each client's batch size, an estimation of the clients' compute time as a function of the number of training examples may be determined. This may be determined by the clients themselves and transmitted to the server (a client-based approach), or may be estimated by the server based on information sent from the clients to the server (a server-based approach). A client with a large number of data points may utilize just a subset of its dataset during training in order to meet a reference time duration T_{ref}, which may refer to a particular amount of time in which clients may be assigned to perform an update. The batch size selected for each client may be based on the maximum amount of data the client may use in computing an update such that the update may be performed within the time indicated by T_{ref}.

In a client-based approach, clients may provide to the central server the value T_{ref} and a number of datapoints (or batch size) per client for each training round. In this case, the server will receive T_{ref} from multiple clients. The server can then determine to use the maximum value of the T_{ref} values provided by the clients (in a more conservative approach) or may use a median or mean of the T_{ref} values provided by the clients (in a slightly more aggressive approach). The server may then share the resulting T_{ref} back to the clients so that the clients may determine their batch size for use in the federated learning rounds.

In a server-based approach, the server may send the T_{ref} value to the clients, and the clients may in turn determine their respective batch sizes to be used in the rounds of federated learning. In some cases, the clients may also provide feedback to the server about the chosen value of T_{ref}, e.g., to indicate that the chosen T_{ref} value is too small for the client to compute an unbiased estimate of the gradient.

In some cases, the compute capability of the clients (as well as the number of training examples nₖ at each client) can vary largely. The amount of time needed by the clients to compute a weight update wₜ₊₁^{k} may depend on at least one of the following factors: (1) size of the model (for example, neural network (NN)); (2) compute capability of the clients; or (3) number of training examples (data) at the client. It is also important to note that at the end of each round, the computation of the global weight in Equation (C3) below depends on the availability of weight updates from each of the K clients. In other words, the computation of global weight at each step is limited by the slowest client in the set of K clients. Accordingly, in certain embodiments, batch sizes of data used to compute updates at the clients may be determined such that the compute times of all the clients are comparable. This approach can significantly reduce the round-trip time for computing global weights at each round and as a result reduce the actual time taken for the model to converge.

Selecting a batch size for client that will represent all training examples at that client can be considered as effectively determining a hyper-parameter of a stochastic gradient descent (SGD) for that client. In other words, the gradient computed using all available training data is estimated by the gradient computed using smaller subset (or batch) of available training data. This estimated gradient has a deviation from the true gradient of interest for that client. This deviation eventually affects the number of global epochs required for the algorithm to converge. For example, in the case of Gaussian I.I.D data, the standard error of the mean of the gradients is given by σ/√n, where σ is the true standard gradient of the data and n is the batch size over which gradient is computed. The larger the batch size is, the smaller the deviation of the gradient, but there may also exist a certain n for which the standard error is acceptable. The smaller the deviation of the gradient is, the smaller the number of global epochs required for the model to converge.

Though it might not possible to control the number of global epochs required for the training algorithm to converge directly, we can control the deviation (or variance) in the gradient estimate at each client by controlling the batch size. Since the relationship between batch size and gradient variation depends on the available training data at the client, the minimum batch size needed to maintain a deviation smaller than certain threshold may be calculated (e.g., at the client). This minimum batch size may be indicated by b_{k,min}. Since this deviation may depend on the instantaneous values of machine learning (ML) parameters, this minimum batch size per client (b_{k,min}) may need to be updated as often as each client can afford to compute. That is, in certain instance, the minimum batch size may vary for each round of learning.

In some embodiments, a client can perform the following operations to determine a minimum batch size (b_{k,min}). First, a client k gets informed about the batch size selection for that round (bₖ), e.g., by the central server, and client k computes the gradient over bₖ examples and sends it to the server. After sending the gradient to the server, the client can continue to estimate the gradient update under different selections of bₖ whenever compute resources are idle or otherwise available for use (e.g., during communication, or whenever this client is not chosen to participate in a global training epoch). The client can then determine a minimum batch size that bounds the gradient estimate around a certain deviation (b_{k,min}). This process can span multiple global epochs, as the client does not need to estimate b_{k,min} after every global epoch. The client can then inform the server about its selection of bₖ, e.g., if the selected batch size was too small.

Server-Based Approach

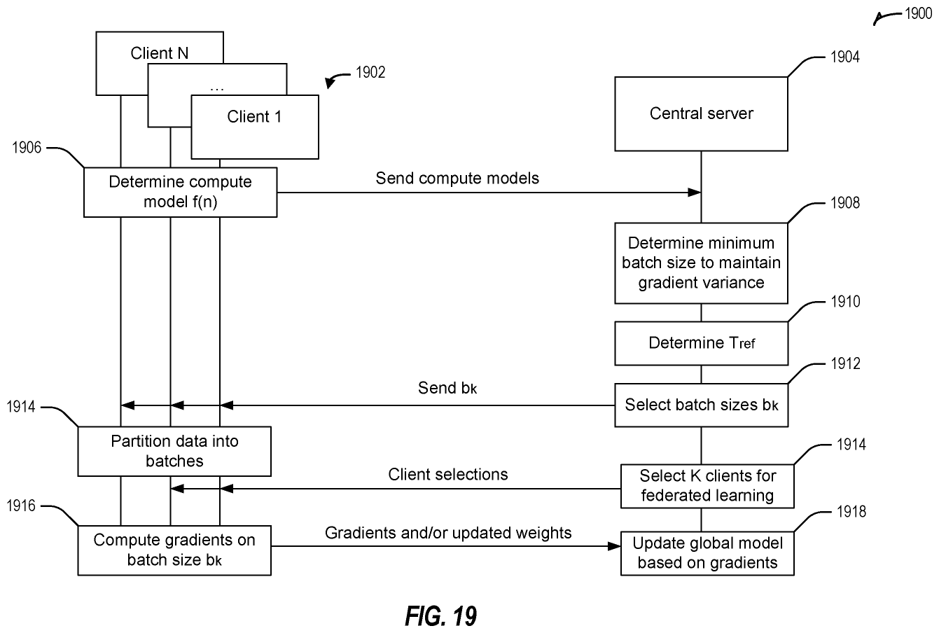

FIG. 19 illustrates a flow diagram of an example server-based process 1900 for performing compute-aware batch size selection. The example process may be implemented in software, firmware, hardware, or a combination thereof. For example, in some embodiments, operations in the example process shown may be performed by one or more components of an edge computing node, such as processor(s) of client devices 1420 (which may be similar to client computing nodes 1202 of FIG. 12) or processor(s) of central server 1410 (which may be similar to central server 1208 of FIG. 12). In some embodiments, one or more computer-readable media may be encoded with instructions that implement one or more of the operations in the example process below when executed by a machine (e.g., a processor of a computing node). The example process may include additional or different operations, and the operations may be performed in the order shown or in another order. In some cases, one or more of the operations shown in FIG. 19 are implemented as processes that include multiple operations, sub-processes, or other types of routines. In some cases, operations can be combined, performed in another order, performed in parallel, iterated, or otherwise repeated or performed another manner.

In server-based approaches such as the example shown, clients 1902 may provide a compute model to the server 1904 that relates approximate compute times with batch sizes at 1906. In some cases, clients may have non-linear behavior in their compute times. To this end, a compute model may be defined by fₖ(nₖ) where f(.) represents the compute time as a function of the number of training examples. In some cases, f(.) can be a linear function, in which case the clients may indicate only the compute time per training example to the server.

The server at 1908 may utilize the compute model provided by the clients to determine the minimum batch size bₘᵢₙ needed given the gradient variance is bounded. This may be empirically obtained based on the training algorithm and the hyperparameters. For example, a batch size of 100 training examples may approximate the gradient estimates relatively well for purely gradient-based algorithms. Based on bₘᵢₙ, the server may determine at 1910 a nominal compute time T_{ref} as time taken for the slowest client to train on b examples.

The batch sizes bₖ of different clients are then selected at 1912 as bₖ=min(bₘᵢₙ, fₖ⁻¹(T_{ref})) such that the compute times of all clients≈T_{ref}. In cases were clients have b training examples smaller than bₘᵢₙ, the batch size may be set as b for the client, and the clients can make copies of their data when they perform their local update. Then the number of batches at the clients is given by vₖ=[nₖ/bₖ], where nₖ is the number of training examples on the k-th client.

The batch sizes are then communicated to the clients. Each client may partition its training data at 1914 using the batch size bₖ and only computes the weight updates on a number of training examples equal to the batch size bₖ in each round. In some embodiments, the clients may also provide feedback to server if the selection of bₖ is too small to maintain a small deviation from the true gradient if such feedback is available.

In order to preserve the ratio in Equation (C3) below, the clients may be selected in the ratio of the number of batches available to each client. That is, if a client has a relatively large number of batches out of the total number of batches across all clients, then it may have a higher probability of being selected during a federated learning epoch.

An example federated learning algorithm using compute-aware batch size selection may then be defined as follows. First, the clients are selected at 1914. The clients may be sampled based on the ratios of vₖ/Σₖ^{N}vₖ (i.e., based on the ratios of the number of batches at each client out of the total number of batches across all clients). This may be ensure that sampling is equivalent to (or approximately equivalent to) sampling a batch uniformly from a set of all batches where a single client may contain one or more batches.

Next, at 1916, each client k computes gradients over the selected batch as described in Equations (C1) and (C2). The clients ensure the batches are selected uniformly for each round that the client is selected.

$${g}_{k} = \frac{1}{{b}_{k}} {\sum }_{i}^{{b}_{k}} {∇}_{w} L ( x , y ; w ) ; ∀ k ∈ K , \qquad ( C1 )$$

$${w}_{t + 1}^{k} = {w}_{t}^{k} - η {g}_{k} . \qquad ( C 2 )$$

The central server at 1918 then combines the weights from all clients as

$${w}_{t + 1} = \frac{1}{{\sum }_{k}^{K} {b}_{k}} {\sum }_{k}^{K} {b}_{k} {w}_{t + 1}^{k} . \qquad ( C3 )$$

Client-Based Approach

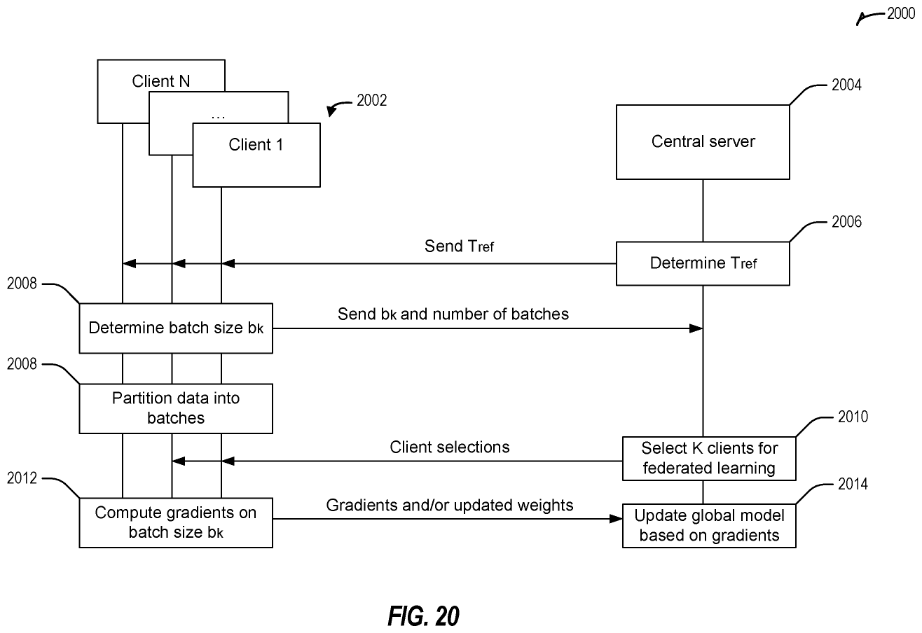

FIG. 20 illustrates a flow diagram of an example client-based process 2000 for performing compute-aware batch size selection. The example process may be implemented in software, firmware, hardware, or a combination thereof. For example, in some embodiments, operations in the example process shown may be performed by one or more components of an edge computing node, such as processor(s) of client devices 1420 (which may be similar to client computing nodes 1202 of FIG. 12) or processor(s) of central server 1410 (which may be similar to central server 1208 of FIG. 12). In some embodiments, one or more computer-readable media may be encoded with instructions that implement one or more of the operations in the example process below when executed by a machine (e.g., a processor of a computing node). The example process may include additional or different operations, and the operations may be performed in the order shown or in another order. In some cases, one or more of the operations shown in FIG. 20 are implemented as processes that include multiple operations, sub-processes, or other types of routines. In some cases, operations can be combined, performed in another order, performed in parallel, iterated, or otherwise repeated or performed another manner.

In client-based approaches such as the example shown, instead of sharing the compute functions fₖ(.) to the server as in the server-based approaches, the clients 2002 can directly determine the local batch sizes bₖ based on a nominal compute time T_{ref} determined by the server 2004. For example, the server may first determine T_{ref} at 2006 based on information such as the specific use case, e.g., how often the server would like an update, the network size, etc. In one embodiment, the server also receives the past updates from clients. Based on this, the server can estimate clients' fₖ(.). Using this, the server can recommend T_{ref} such that the slowest client will also be able to train on at least bₘᵢₙ training examples.

The clients receive T_{ref} and determine their batch sizes bₖ at 2008 that meets the T_{ref} provided by the server. The clients may also communicate the number of batches available vₖ to the server, so that the server can select clients in the ratios vₖ/Σₖ^{N}vₖ as described above. The clients may also provide feedback to server if the selection of T_{ref} is too small to maintain a small deviation from the true gradient, if such feedback is available. Client selection 2010, gradient computation 2012, and weight update and weight combining 2014 may then be performed as described above with respect to the server-based approach.

### K. Automated ML Approaches for Federated Learning

In some instances, some clients may have limited computational resource or poor wireless channels, causing issues to typical federated learning approaches, e.g., the straggler problem described above. This can lead to longer parameter update and/or upload times. Both may cause an inability of the server to update the global model in a timely fashion, sometimes rendering it very difficult or impossible to perform the aggregate update to the central model synchronously. Causes for this issue can includes poor link quality of some of the clients and heterogeneity in computational ability at the various clients. Additional challenges are imposed when clients' data distributions are not IID. The following proposes efficient techniques that utilize reinforcement learning (RL) to directly learn which set of clients to select for participation in the rounds of federated learning such that key objectives can be achieved (e.g., minimizing the overall training time or achieving a minimal set of updates necessary to satisfy the central model's accuracy). In addition, the following proposes a reinforcement learning agent that also determines compute hyper-parameters (learning rate) along with the communication parameters (radio resources to be allocated to the clients) to satisfy certain performance metrics.

Previous methods proposed to reduce the uplink communication costs have included using structured updates and sketched updates. Control algorithms that determine the optimal schedules for performing parameter updates to the global model have also been proposed. These methods, however, do not regulate the users that participate in the global update in order to make the training process more efficient. One current proposal, for example, aims to only select clients based on their resource capability and those clients that can satisfy a certain delay deadline. However, such a proposal works only as long as the training algorithm and the associated complexity does not change. Further, there is lot of hand-tuning involved (i.e., manual modification/testing of parameters) to carefully craft the deadline parameter, since it may vary for different ML training algorithms, as well as based on the sensitivity of the model at different times. Automating the client selection at the central server as proposed herein to determine the clients based on experience may avoid the overhead time and cost associated with handcrafting rules for the client selection.

Some embodiments may utilize a machine learning (ML) approach, specifically, an end-to-end deep reinforcement learning (RL), that allows a central server to select clients to participate in an aggregate gradient update for each training epoch. The proposed methods herein allow agents to interact with the environment (e.g., a system similar to system 1200 of FIG. 12) and take actions that increasingly allow for maximization of the expected long-term rewards.

There may be several advantages realized by applying a deep RL approach to schedule the set of federated learning clients during each training epoch. For example, careful handcrafting/hand-tuning may be avoided since deep RL algorithms can adapt to changes in the underlying learning algorithm as well as the KPI of interest. This can be achieved by retraining the deep RL model as the environment (characterized by the specific federated learning algorithm, key performance indicators (KPIs) of the federated learning performance such as training accuracy, convergence time, etc.) changes. Statistical modeling of computation time at federated nodes, link quality estimation, data quality, etc. can also be avoided. In addition, such techniques may provide robustness to noisy observations from clients, as deep RL approaches are generally more robust to partial observability of the environment, such as the delay in feedback from clients regarding their resource capabilities, feedback from clients on the quality of the data set they have including the number of training samples. Further, available data may be used to automate the client selection. For instance, training data such as client capabilities in terms of computation, bandwidth availability, etc. can be used. Also, feedback may be available in terms of training performance. Thus, a reinforcement approach can automate client selection for federated learning while also being adaptable to changing conditions.

Although radio resource allocation currently is agnostic to the machine learning workloads, such approaches are becoming increasingly important learning at the edge becoming increasingly a dominant type of workload and requiring significant communication bandwidths. Standards such as Federated Learning International Standard (IEEE P3652.1) are being developed in order to develop a unified federated learning tool to be utilized by different entities as well as to spur innovation. Integration of distributed/federated learning into the wireless standards may eventually take place where radio resource management will also be sensitive to distributed/federated learning workloads.

Deep RL Background

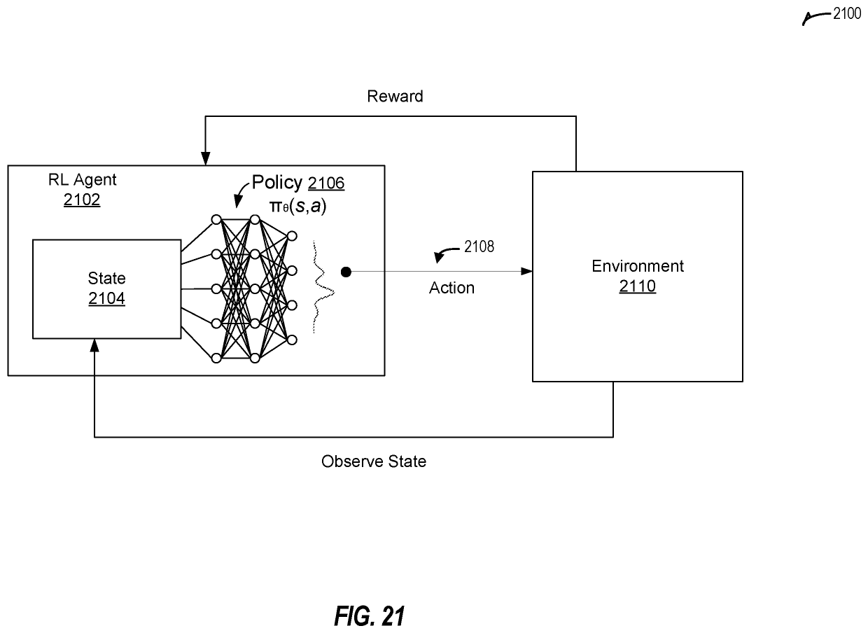

FIG. 21 illustrates an example reinforcement learning (RL) model that may be used in federated learning embodiments. In the example shown, an RL agent 2102, which may be on a server (e.g., central server 1208 of FIG. 12) interacts directly with the environment 2110 (e.g., the system 1200 of FIG. 12) by observing the system state sₜ (2104) and performing an action aₜ (2108) based on a policy (2106). Following each action, the system undergoes a state transition to sₜ₊₁ and the agent receives a reward rₜ. It can be assumed that the state transitions and rewards are stochastic and Markovian in nature. The agent may be unaware initially of the state transitions and the rewards but may interact with the environment 2110 and observe these quantities. The objective of the RL agent 2102 may generally be to maximize the expected cumulative discounted reward E[Σₜ₌₀^{∞}γ^{t}r^{t}].

The agent 2102 is guided by a stochastic policy 7C 2106 that maps from state s 2104 to action a 2108. Hence, the policy 2106 may be described as a probability distribution over state action pairs, i.e., π(s,a)→[0, 1]. To handle the exploding number of possibilities for the {s,a} pair and the resulting “curse of dimensionality”, deep neural networks (DNN) may be utilized to approximate the policy 2106, as shown in FIG. 21. Hence, the policy may be parametrized using θ as π₀(s,a). One potential advantage of using DNNs is to avoid needing to hand-tune parameters.

An example use case for federated learning may include a system in which mobile devices run an image classification algorithm to predict which photos are most likely to be viewed/shared multiple times in the future. For such algorithms, the data needs to be local to the mobile devices. However, a global model trained from multiple users can make a robust ML classification. Hence, federated learning may be utilized where devices are chosen in each training round to participate in the federated update. Specifically, K clients can be scheduled in each training epoch/round to send gradient updates (e.g., as described above) along with other hyper-parameters (e.g., the learning rate, number of local iterations, redundancy, transmit power and bandwidth for the clients), which can be used for RL as described herein.

The following describes example state and action representations and reward signals for a RL model that can be used to train a federated learning algorithm in accordance with embodiments of the present disclosure.

State Representation

An example state space (e.g., 2104 of FIG. 21) may include one or more of the following observations in the environment (e.g., 2110 of FIG. 21).

Statistics of parameter updates across clients: Gradient updates from each client can inform how similar or dissimilar the clients' updates are with respect to each other. This can also help in providing some insight regarding the client data (e.g., a degree of non-I.I.Dness). Therefore, in some embodiments, the mean magnitude (|μ_{Δw}|) and standard deviation (σ_{Δw}) of the gradient/weight updates across clients may be utilized as a state parameter input to the policy (e.g., 2106).

Cosine similarity of local parameter updates with global parameter update: The cosine similarity of the gradient/weight updates of each client with respect to the global update can also inform how close the local updates are to the overall update. Thus, in some embodiments, the mean of the cosine similarities of each client's local parameter updates with respect to the global update may be utilized as a state parameter input to the policy (e.g., 2106).

Training and Validation Loss: Loss metrics may also be informative of the current training performance and allow the RL policy (e.g., 2106) to adapt the hyper-parameters to speedup learning. Accordingly, in some embodiments, such loss metrics may be utilized as a state parameter input to the policy (e.g., 2106).

Current lr and number of local epochs: In some embodiments, a current learning rate (lr) at the clients and/or number of local epochs (tau) may be utilized as a state parameter input to the policy (e.g., 2106).

Number of training examples at the federated node t (nₜ): In some embodiments, the number of training examples at each client node may be utilized as a state parameter input to the policy (e.g., 2106). This can be an average estimate at the central server based on historical information from the federated node t or a real-time report of the number of training examples (e.g., images). Each node t can report this information back to the central server at a certain periodicity.

Average Rate supported over the wireless link between node t and central server (Rₜ): Most wireless systems allow channel quality feedback from the receiver (client) to the transmitter (central server) for the short term. Further, from the location of the clients couple with the time varying nature of channel, the average rate quantity can calculated. Further, a bandwidth supported by the client node can be sent to the server. Based on this information, an average rate over the wireless link can be estimated and may be utilized as a state parameter input to the policy (e.g., 2106).

Energy budget: A client energy budget may be an important attribute that determines the degree of participation of clients in federated learning. This may depend on the form-factor of the clients, energy utilization, number of processes running, etc. Based on this, in some embodiments, clients can report energy budget information that indicates an acceptable amount of energy for the client to carry out federated learning computations. The energy budget information may be utilized as a state parameter input to the policy (e.g., 2106).

Time to compute gradient per data point (Tcₜ): It may be important to measure a computational time required at a client to perform a gradient update. This quantity may allow a central server-based deep RL agent to understand the computational capacity available at each client t. Thus, clients may periodically report this the computational time to the central server, and the value received from the clients may be utilized as a state parameter input to the policy (e.g., 2106).

Memory access time (Tmₜ). This may refer to a measure of an amount of time needed to perform memory read/write access at each client t. This can be measured on a per-model/gradient calculation basis in some cases. Clients can transmit (e.g., periodically) their average values of Tmₜ to the central server. In some cases, the value T_{ref} described above with respect to compute-aware batch sizes can be determined and sent to the central server instead of Tcₜ to estimate a compute time at each client. In either case, the values sent to the central server may be utilized as a state parameter input to the policy (e.g., 2106).

Action Representation

An example action space may include one or more of the following actions (e.g., 2108 of FIG. 21) in the environment (e.g., 2110 of FIG. 21):

Sampling probability for clients: Vector p={p₁, . . . ,p_{N}} indicating sampling probability for clients.

Coding redundancy: Vector c={c₁, . . . ,c_{N}} where each client t can send to the central server a coding redundancy cₜ corresponding to their data (xₜ,yₜ) in addition to the gradient update. Coding redundancy has been shown to improve the training accuracy and convergence time of federated learning. The amount of coding redundancy to be added is still an open problem and the provided framework can help learn this parameter. The coding redundancy value may be used by the central server to implement coded federated learning (CFL) techniques in the environment as described in International Application No. PCT/US2020/067068.

Uplink transmit power: Vector E={E₁, . . . ,E_{N}} indicating the uplink transmit power for clients may be used. The uplink transmit power value may refer to an amount of energy/power used by a radio of the client to transmit information to the central server.

Bandwidth: Vector b={b₁, . . . ,b_{N}} indicating bandwidth assigned for clients may be used. The bandwidth value may indicate an amount of bandwidth to be allocated to a wireless link between the client N and a base station or the central server.

Scaling factor: A scaling factor may be used in certain embodiments and may be applied to the hyper-parameters of the federated learning process, e.g., the learning rate, number of local iterations, etc. This scaling factor may help normalize learning or response times between the various clients.

Training hyper-parameters may include (but are not limited to) the learning rate or weight regularization coefficients for the global model.

Reward Signals

The reward signals drive the RL agent 2102 towards learning a policy 2106 (e.g., a NN) that will optimize the expected long-term average reward observed by the RL agent 2102. One example reward signal for the RL agent 2102 to observe or evaluate includes a ratio of the test accuracy (A^{r}) value for the global model to the update time (Tu^{r}) at epoch r. The test accuracy value can be measured in many ways. For example, where the global model is a classification problem, the inverse of logarithmic loss can be a good measure of the classifier's accuracy. Another accuracy metric can be calculated from a Confusion matrix by evaluating (TruePositive+FalseNegative)/TotalNumberOfSamples. RL allows developing several reward signals that do not need to be differentiable with respect to the model parameters. Another reward signal that may be observed or evaluated by the RL agent 2102 is the −log (TestLoss).

Example Training Algorithm—Policy Gradient Method

In some embodiments, a policy gradient method may be used to train the RL agent. In order to allow the agent to make rewarding policies, the agent may first go through a training phase during which the agent experiments with different actions while updating the expected reward over a fixed time horizon. To deal with the long convergence due to the black-box nature of reinforcement learning, during the training stage of the RL agent, the clients may only perform training on a fraction of the overall dataset. Upon convergence of the RL agent, the federated learning hyper-parameters may be fixed and the clients can perform training on the complete dataset. An example policy gradient based training algorithm is described in detail below.

In the Deep RL training phase of this example, the following may be performed during each training episode. For each epoch of the federated learning, the central server first collects the inputs required from the client nodes or calculates estimates of these (e.g., statistical average) to obtain the input state (e.g., 2104) to the policy gradient network (e.g., 2106). This may involve handshake messages between the central server and clients. Next, the central server may send a broadcast METADATA request to the clients, and the clients respond with METADATA response indicating one or more of the following information: (1) Number of training examples at the federated node t (nₜ), (2) Average rate supported over the wireless link between client t and central server (Rₜ), (3) Time to compute gradient per data point (Tcₜ), (4) Memory access time (Tmₜ), and (5) Energy budget (Bₜ), (6) Statistics of parameter updates across clients, (7) Cosine similarity of local parameter updates with global parameter update, (8) Training and Validation Loss, (9) Current lr and number of local epochs. Alternatively, the client behavior can be emulated “offline” by processes running at the central server generating the states randomly or according to some well-known distributions providing ensemble of the states to approximately model the underlying Markov-Decision Process.

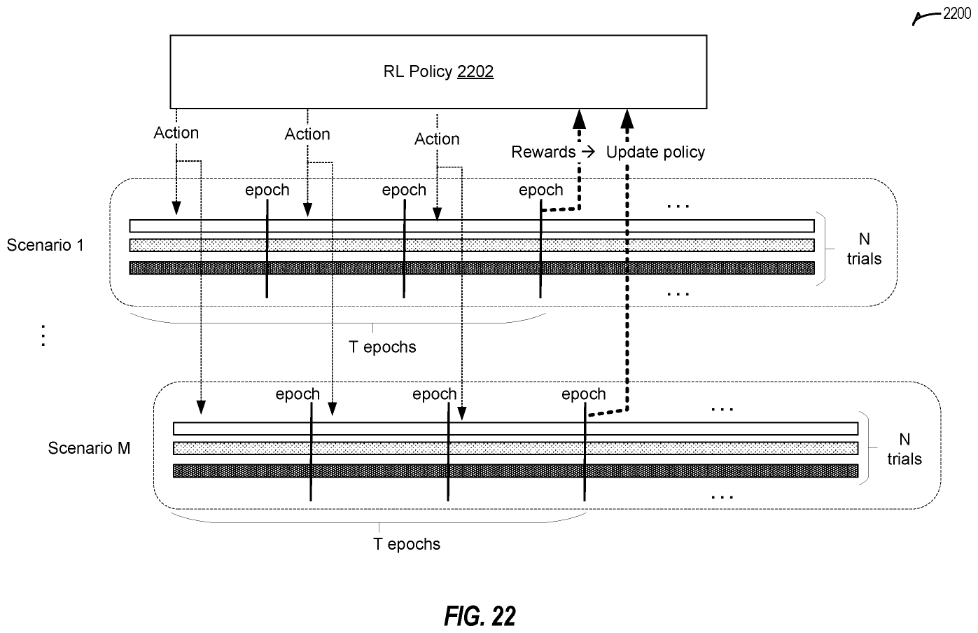

FIG. 22 illustrates an example training architecture for RL based optimization of federated learning. In order to allow an RL policy to learn from diverse conditions, several scenarios may be spawned in parallel. Example scenarios can include, e.g., the data distribution across clients, number of clients in federated learning and dataset, communication/compute capabilities of devices. Different initialization of the policy weights can be utilized, such as, for example, random initialization, Xavier initialization, etc. Once a set of scenarios are selected for training (e.g., M scenarios as shown in FIG. 22), several trials (e.g., N trials as shown in FIG. 22) are spawned for each scenario. The trials share the same initial model and scenario parameters. The policy weights are shared across all scenarios and trials to allow the system to learn a unified policy that performs well in different scenarios.

Each trial progresses independently, where actions are sampled from the RL policy network 2202 given the state of each trial at every global epoch. Even though the trials share the same policy, they will gradually diverge as the policy is stochastic and can yield different actions in each trial. A reward is obtained for every action after each global epoch in every trial in every scenario. After every policy interval (e.g., a number of global epochs after a policy update), the state, action, and rewards for the set of global epochs are collected. When multiple scenarios are executed, the state, action, and reward tuples are collected from all the scenarios for the set of global epochs into a common buffer. The RL policy network 2202 is then updated, utilizing these experiences (state, action, reward). Several approaches can be utilized to update the policy network (e.g., policy gradient, proximal policy optimization (PPO)). After a policy update, the initial states of all the trials within a scenario are set to the same and the next global epoch is executed by repeating the above steps.

The policy network converges after several policy updates. In some embodiments, the policy network could be continuously trained until federated learning scenarios are completed (i.e., federated learning networks are fully trained). In other embodiments, policy network can be trained until their convergence and the policy network parameters frozen for subsequent global epochs. In another embodiment, the policy network can be updated whenever the environment undergoes a change (e.g., when the number of clients changes, i.e., new devices arriving/leaving, or other triggers).

### Training Algorithm— Q-Learning and Deep Q-Networks (DQN) Method

In some embodiments, Q-learning and/or deep Q-networks (DQN) may be used to train the RL agent. For instance, for each state-action pair, there may be a Q-function that is the expected reward given the state s, taking action a and then following a policy π. The Q-function may given as:

Q_{π}(s,a)=E_{π}[Rₜ|Sₜ=s,Aₜ=a].

By maximizing the Q-function, an optimal policy can be applied that maximizes the expected accumulated discounted reward from any state action pair (s,a). That is, Q-learning aims to find the optimal sequence of actions that maximize the long-term reward.

For the user selection problem, the state-action space can grow exponentially as shown before. To deal with this, a deep neural network (DNN) can be utilized to approximate the Q-function in the form of a DQN Q_{π}(s, a; θ) with θ being the parameter of the DQN.

In an example DQN training algorithm, for each training iteration i: an input may include the state-action pair (s,a). The loss function E[(yᵢ−Q(s,a; θ))²] may then be calculated using yᵢ=E[r+γ max_{a′} Q(s′,a′; θᵢ₋₁)], which is calculated using the same Q-network using old weights. The output may then be a Q-value for the given input (s,a).

Extensions

Once the agent has trained on sufficient training examples (which can be determined by observing the learning curve), the agent can be deployed in a real-world environment to perform client selection as well as hyper-parameter selection. It is also possible, depending on the implementation, to train the RL agent online continuously by allowing it to update its parameters after observing the input states. An alternative approach to this could be to periodically train the policy/Q-network to adapt to new variations in the system dynamics.

### L. Example Edge Computing Implementations

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

As referred to below, an “apparatus of” an edge computing node is meant to refer to a “component” of “node,” such as of a central node, central server, server, client node, client computing node, client device, client or user, as the component is defined above. A client, client node, or client compute/computing node may refer to an edge computing node that is serving as a client device and, in the examples below, may perform training of a global model using local data, which the client may wish to keep private (e.g., from other nodes). The “apparatus” as referred to herein may refer, for example, to a processor such as processor 852 of edge computing node 950 FIG. 9, or to the processor 852 of FIG. 9 along with any other components of the edge computing node 950 of FIG. 9, or, for example to circuitry corresponding to a computing node 515 or 523 with virtualized processing capabilities as described in FIG. 5.

### EXAMPLES

Example 1 includes an apparatus of an edge computing node to be operated in an edge computing network, the apparatus including an interconnect interface to connect the apparatus to one or more components of the edge computing node, and a processor to: cause an initial set of weights for a global machine learning (ML) model to be transmitted a set of client compute nodes of the edge computing network; process Hessians computed by each of the client compute nodes based on a dataset stored on the client compute node; evaluate a gradient expression for the ML model based on a second dataset and an updated set of weights received from the client compute nodes; and generate a meta-updated set of weights for the global model based on the initial set of weights, the Hessians received, and the evaluated gradient expression.

Example 2 includes the subject matter of Example 1, wherein the processor is to generate the meta-updated set of weights according to:

$${w}_{t + 1} = {w}_{t} - α \frac{1}{{\sum }_{k}^{K} {n}_{k}} {\sum }_{k}^{K} {n}_{k} ( I - β {h}_{k} ) {g}_{k} ( {\overline{w}}_{t + 1}^{k} )$$

where wₜ₊₁ represents the meta-updated set of weights, wₜ represents the initial set of weights, α represents a learning rate for the ML model, I represents an identity matrix, β represents a gradient step size for the ML model, hₖ represents the Hessian from the k-th client compute node, and gₖ(w̅ₜ₊₁^{k}) represents the evaluated gradient expression of the ML model for the k-th client compute node.

Example 3 includes the subject matter of Example 1 or 2, wherein the processor is to select the set of client compute nodes randomly from a larger set of client compute nodes.

Example 4 includes the subject matter of Example 1 or 2, wherein the processor is further to cluster a larger set of client compute nodes based on their data distributions and select the set of client compute nodes from the larger set of client compute nodes based on the clustering.

Example 5 includes the subject matter of Example 4, wherein the processor is to perform the clustering based on probability mass function information or a distance metric indicating a distance between data distributions for data on the client compute nodes.

Example 6 includes the subject matter of Example 5, wherein the probability mass function information includes a probability mass function of label data associated with training examples of the client compute nodes.

Example 7 includes the subject matter of Example 5, wherein the distance metric is a KL-divergence metric.

Example 8 includes the subject matter of Example 1 or 4, wherein the set of client compute nodes are selected based at least in part on one or more of communication capability or compute ability received from each client compute node from a larger set of client compute nodes.

Example 9 includes the subject matter of Example 4, wherein the clustering is based on Bregman's k-means clustering or affinity propagation analysis.

Example 10 includes the subject matter of any one of Examples 1-9, wherein the dataset stored on the client and the second dataset each include a set of training examples and a set of label values associated with the training examples.

Example 11 includes the subject matter of any one of Examples 1-10, wherein the processor is further to: determine a data batch size for each of a plurality of client compute nodes, wherein the data batch size for each client compute node is based on compute capabilities of the client compute node and indicates a number of training examples to be used by the client compute node in performing a round of federated machine learning training; and cause the data batch size determined for each client compute node to be transmitted to the corresponding client compute node.

Example 12 includes the subject matter of any one of Examples 1-10, wherein the processor is further to: determine a reference time indicating an amount of time in which clients are to perform a round of federated machine learning training; cause the reference time to be transmitted to each of a plurality of clients of the edge computing network; and obtain data batch size information from each client indicating a number of training examples to be used by the client to perform a round of federated machine learning training within the reference time.

Example 13 includes the subject matter of any one of Examples 1-12, further comprising performing reinforcement learning to determine hyper-parameters for federated ML training of the global ML model, including: obtaining state information from clients of the edge computing network; selecting a set of action vectors corresponding to the hyper-parameters; performing rounds of a federated ML training within the edge computing network using the action vectors to update the global ML model; and determining a measure of accuracy of the updated global ML model.

Example 14 includes the subject matter of Example 13, wherein the state information comprises one or more of statistics of ML parameter updates from each client compute node of the edge computing network, a cosine similarity of ML parameter updates from each client compute node, loss metrics for each client compute node, a learning rate for each client compute node, a number of local federated ML training epochs performed by each client compute node, a number training data samples used by each client compute node, an average data rate supported between the client compute node and the central server, an energy budget of the client compute node, a time to compute a gradient update at each client compute node, and a time to perform a memory access at each client compute node.

Example 15 includes the subject matter of Example 13, wherein the action vectors comprise one or more of a sampling probability for each client compute node, a coding redundancy to be used by each client compute node for coded federated ML training, an uplink transmit power to be used by the client compute node, a bandwidth to be allocated to the client compute node, and a scaling factor to be applied to the hyper-parameters.

Example 16 includes the subject matter of Example 13, wherein the hyper-parameters determined via the reinforcement learning comprise one or more of a learning rate for the federated ML training and a weight regularization coefficient.

Example 17 includes the subject matter of any of Examples 13-16, further comprising performing the reinforcement learning across multiple hyper-parameter scenarios using a plurality of trials.

Example 18 includes a method to be performed at an edge computing node in an edge computing network, the method comprising: transmitting an initial set of weights for a global machine learning (ML) model to a set of client compute nodes of the edge computing network; receiving, from each of the client compute nodes, a Hessian computed based on a dataset stored on the client compute node and an updated set of weights computed based on a gradient computed based on the dataset; evaluating a gradient expression for the ML model based on the updated set of weights and a second dataset; and generating a meta-updated set of weights for the global model based on the initial set of weights, the Hessians received, and the evaluated gradient expression.

Example 19 includes the subject matter of Example 18, wherein the meta-updated set of weights are generated according to:

$${w}_{t + 1} = {w}_{t} - α \frac{1}{{\sum }_{k}^{K} {n}_{k}} {\sum }_{k}^{K} {n}_{k} ( I - β {h}_{k} ) {g}_{k} ( {\overline{w}}_{t + 1}^{k} )$$

where wₜ₊₁ represents the meta-updated set of weights, wₜ represents the initial set of weights, α represents a learning rate for the ML model, I represents an identity matrix, β represents a gradient step size for the ML model, hₖ represents the Hessian from the k-th client compute node, and gₖ(w̅ₜ₊₁^{k}) represents the evaluated gradient expression of the ML model for the k-th client compute node.

Example 20 the subject matter of Example 18 or 19, wherein the set of client compute nodes are selected randomly from a larger set of client compute nodes.

Example 21 includes the subject matter of Example 18 or 19, further comprising clustering a larger set of client compute nodes based on their data distributions, wherein the set of client compute nodes are selected based on the clustering.

Example 22 includes the subject matter of Example 21, wherein the clustering is based on probability mass function information or a distance metric indicating a distance between data distributions for data on the client compute nodes.

Example 23 includes the subject matter of Example 22, wherein the probability mass function information includes a probability mass function of label data associated with training examples of the client compute nodes.

Example 24 includes the subject matter of Example 22, wherein the distance metric is a KL-divergence metric.

Example 25 includes the subject matter of Example 18 or 21, wherein the set of client compute nodes are selected based at least in part on one or more of communication capability or compute ability received from each client compute node from a larger set of client compute nodes.

Example 26 includes the subject matter of Example 21, wherein the clustering is based on Bregman's k-means clustering or affinity propagation analysis.

Example 27 includes the subject matter of any one of Examples 18-26, wherein the dataset stored on the client and the second dataset each include a set of training examples and a set of label values associated with the training examples.

Example 28 includes the subject matter of any one of Examples 18-27, further comprising: determining a data batch size for each of a plurality of client compute nodes, wherein the data batch size for each client compute node is based on compute capabilities of the client compute node and indicates a number of training examples to be used by the client compute node in performing a round of federated machine learning training; and transmitting the determined data batch sizes to the corresponding client compute nodes.

Example 29 includes the subject matter of any one of Examples 18-27, further comprising: determining a reference time indicating an amount of time in which clients are to perform a round of federated machine learning training; causing the reference time to be sent to each of a plurality of clients of the edge computing network; and obtaining data batch size information from each client indicating a number of training examples to be used by the client to perform a round of federated machine learning training within the reference time.

Example 30 includes the subject matter of any one of Examples 18-29, further comprising performing reinforcement learning to determine hyper-parameters for federated ML training of the global ML model, including: obtaining state information from clients of the edge computing network; selecting a set of action vectors corresponding to the hyper-parameters; performing rounds of a federated ML training within the edge computing network using the action vectors to update the global ML model; and determining a measure of accuracy of the updated global ML model.

Example 31 includes the subject matter of Example 30, wherein the state information comprises one or more of statistics of ML parameter updates from each client compute node of the edge computing network, a cosine similarity of ML parameter updates from each client compute node, loss metrics for each client compute node, a learning rate for each client compute node, a number of local federated ML training epochs performed by each client compute node, a number training data samples used by each client compute node, an average data rate supported between the client compute node and the central server, an energy budget of the client compute node, a time to compute a gradient update at each client compute node, and a time to perform a memory access at each client compute node.

Example 32includes the subject matter of Example 30, wherein the action vectors comprise one or more of a sampling probability for each client compute node, a coding redundancy to be used by each client compute node for coded federated ML training, an uplink transmit power to be used by the client compute node, a bandwidth to be allocated to the client compute node, and a scaling factor to be applied to the hyper-parameters.

Example 33 includes the subject matter of Example 30, wherein the hyper-parameters determined via the reinforcement learning comprise one or more of a learning rate for the federated ML training and a weight regularization coefficient.

Example 34 includes the subject matter of any one of Examples 30-33, further comprising performing the reinforcement learning across multiple hyper-parameter scenarios using a plurality of trials.

Example 35 includes an apparatus of an edge computing node to be operated in an edge computing network, the apparatus including an interconnect interface to connect the apparatus to one or more components of the edge computing node, and a processor to: process an initial set of weights for a global machine learning (ML) model from a central server of the edge computing network; compute a gradient for the set of weights based on a first dataset; generate an updated set of weights based on the computed gradient; compute a Hessian based on the computed gradient; evaluate a gradient expression for the ML model based on the updated set of weights and a second dataset different from the first dataset; generate a meta-updated set of weights based on the initial set of weights, the Hessian, and the evaluated gradient expression; and cause the meta-update weights to be transmitted the central server to update the global ML model.

Example 36 includes the subject matter of Example 35, wherein the gradient is computed according to:

$${g}_{k} = \frac{1}{{n}_{k}} {\sum }_{i}^{{n}_{k}} {∇}_{w} L ( x , y ; w ) ; ∀ k ∈ K$$

where gₖ represents the gradient, L( ) represents a loss function for the ML model, (x,y) represent the first dataset, and w represents the initial set of weights.

Example 37 includes the subject matter of Example 35 or 36, wherein the processor is to generate the updated set of weights according to:

w̅ₜ₊₁^{k}=wₜ−βgₖ

where w̅ₜ₊₁^{k} represents the updated set of weights, wₜ represents the initial set of weights, β represents a gradient step size for the ML model, and gₖ represents the computed gradient.

Example 38 includes the subject matter of any one of Examples 35-37, wherein the processor is to compute the Hessian based on the first dataset.

Example 39 includes the subject matter of any one of Examples 35-37, wherein the processor is to compute the Hessian based on a third dataset that is different from the first dataset but independent and identically distributed with respect to the first dataset.

Example 40 includes the subject matter of any one of Examples 35-39, wherein the second dataset is received from the central server.

Example 41 includes the subject matter of any one of Examples 35-40, wherein the processor is to generate the meta-updated set of weights according to:

wₜ₊₁^{k}=wₜ−α*(I−βhₖ)gₖ(w̅ₜ₊₁^{k}),

where wₜ₊₁^{k} represents the meta-update weights, wₜ represents the initial set of weights, α represents a learning rate for the ML model, I represents an identity matrix, β represents a gradient step size for the ML model, hₖ represents the Hessian, and gₖ(w̅ₜ₊₁^{k}) represents the evaluated gradient expression of the ML model.

Example 42 includes the subject matter of any one of Examples 35-41, wherein the processor is to generate the updated set of weights by iteratively performing rounds of learning at the client compute node.

Example 43 includes the subject matter of any one of Examples 35-42, wherein the first dataset and second dataset each include a set of training examples and a set of label values associated with the training examples.

Example 44 includes a method to be performed at an edge computing node in an edge computing network, the method comprising: receiving an initial set of weights for a global machine learning (ML) model from a central server of the edge computing network; computing a gradient for the set of weights based on a first dataset; generating an updated set of weights based on the computed gradient; computing a Hessian based on the computed gradient; evaluating a gradient expression for the ML model based on the updated set of weights and a second dataset different from the first dataset; generating a meta-updated set of weights based on the initial set of weights, the Hessian, and the evaluated gradient expression; and transmitting the meta-update weights to the central server to update the global ML model.

Example 45 includes the subject matter of Example 44, wherein the gradient is computed according to:

$${g}_{k} = \frac{1}{{n}_{k}} {\sum }_{i}^{{n}_{k}} {∇}_{w} L ( x , y ; w ) ; ∀ k ∈ K$$

where gₖ represents the gradient, L( ) represents a loss function for the ML model, (x,y) represent the first dataset, and w represents the initial set of weights.

Example 46 includes the subject matter of Example 44 or 45, wherein the updated set of weights are generated according to:

wₜ₊₁^{k}=wₜ−βgₖ

where wₜ₊₁^{k} represents the updated set of weights, wₜ represents the initial set of weights, β represents a gradient step size for the ML model, and gₖ represents the computed gradient.

Example 47 includes the subject matter of any one of Examples 44-46, wherein the Hessian is computed based on the first dataset.

Example 48 includes the subject matter of any one of Examples 44-46, wherein the Hessian is computed based on a third dataset that is different from the first dataset but independent and identically distributed with respect to the first dataset.

Example 49 includes the subject matter of any one of Examples 44-48, wherein the second dataset is received from the central server.

Example 50 includes the subject matter of any one of Examples 44-49, wherein the meta-updated set of weights are generated according to:

wₜ₊₁^{k}=wₜ−α*(I−βhₖ)gₖ(w̅ₜ₊₁^{k}),

where wₜ₊₁^{k} represents the meta-update weights, wₜ represents the initial set of weights, α represents a learning rate for the ML model, I represents an identity matrix, β represents a gradient step size for the ML model, hₖ represents the Hessian, and gₖ(w̅ₜ₊₁^{k}) represents the evaluated gradient expression of the ML model.

Example 51 includes the subject matter of any one of Examples 44-50, wherein generating the updated set of weights comprises iteratively performing rounds of learning at the client compute node.

Example 52 includes the subject matter of any one of Examples 44-51, wherein the first dataset and second dataset each include a set of training examples and a set of label values associated with the training examples.

Example 53 includes an apparatus of an edge computing node to be operated in an edge computing network, the apparatus including an interconnect interface to connect the apparatus to one or more components of the edge computing node, and a processor to: determine a data batch size for each of a plurality of clients of the edge computing network, wherein the data batch size for each client is based on compute capabilities of the client and indicates a number of training examples to be used by the client in performing a round of federated machine learning training; cause the data batch size determined for each client to be sent to the corresponding client; perform a round of a federated machine learning training within the edge computing network by performing operations comprising: selecting a set of clients from the plurality of clients to participate in said round of the federated machine learning training; causing a global model of the machine learning training to be sent to the selected set of clients; and processing updated model weight information for the federated machine learning training obtained from the selected clients, the updated model weight information based on computations performed by each client using the data batch size indicated for the particular client; and updating the global model based on processing the information.

Example 54 includes a method to be performed at an edge computing node in an edge computing network, the method comprising: determining a data batch size for each of a plurality of clients of the edge computing network, wherein the data batch size for each client is based on compute capabilities of the client and indicates a number of training examples to be used by the client in performing a round of federated machine learning training; transmitting the data batch size determined for each client to the corresponding client; performing a round of a federated machine learning training within the edge computing network, including: selecting a set of clients from the plurality of clients to participate in said round of the federated machine learning training; causing a global model of the machine learning training to be sent to the selected set of clients; and processing updated model weight information for the federated machine learning training obtained from the selected clients, the updated model weight information based on computations performed by each client using the data batch size indicated for the particular client; and updating the global model based on processing the information.

Example 55 includes an apparatus of an edge computing node to be operated in an edge computing network, the apparatus including an interconnect interface to connect the apparatus to one or more components of the edge computing node, and a processor to: determine a reference time indicating an amount of time in which clients are to perform a round of federated machine learning training; cause the reference time to be sent to each of a plurality of clients of the edge computing network; obtain data batch size information from each client indicating a number of training examples to be used by the client to perform a round of federated machine learning training within the reference time; perform a round of a federated machine learning training within the edge computing network by performing operations comprising: selecting a set of clients from the plurality of clients to participate in said round of the federated machine learning training; causing a global model of the machine learning training to be sent to the selected set of clients; and processing updated model weight information for the federated machine learning training obtained from the selected clients, the updated model weight information based on computations performed by each client using the data batch size indicated for the particular client; and update the global model based on processing the information.

Example 56 includes a method to be performed at an edge computing node in an edge computing network, the method comprising: determining a reference time indicating an amount of time in which clients are to perform a round of federated machine learning training; transmitting the reference time to each of a plurality of clients of the edge computing network; obtaining data batch size information from each client indicating a number of training examples to be used by the client to perform a round of federated machine learning training within the reference time; performing a round of a federated machine learning training within the edge computing network, including: selecting a set of clients from the plurality of clients to participate in said round of the federated machine learning training; causing a global model of the machine learning training to be sent to the selected set of clients; and processing updated model weight information for the federated machine learning training obtained from the selected clients, the updated model weight information based on computations performed by each client using the data batch size indicated for the particular client; and updating the global model based on processing the information.

Example 57 includes an apparatus of an edge computing node to be operated in an edge computing network, the apparatus including an interconnect interface to connect the apparatus to one or more components of the edge computing node, and a processor to: perform reinforcement learning to determine hyper-parameters for federated machine learning (ML) training of an ML model by performing operations comprising: obtaining state information from clients of the edge computing network; selecting a set of action vectors corresponding to the hyper-parameters; performing rounds of a federated ML training within the edge computing network using the action vectors to update the ML model; and determining a measure of accuracy of the updated ML model; and perform rounds of a federated ML training for the ML model within the edge computing network using hyper-parameters determined via the reinforcement learning.

Example 58 includes the subject matter of Example 57, wherein the state information comprises one or more of statistics of ML parameter updates from each client compute node of the edge computing network, a cosine similarity of ML parameter updates from each client compute node, loss metrics for each client compute node, a learning rate for each client compute node, a number of local federated ML training epochs performed by each client compute node, a number training data samples used by each client compute node, an average data rate supported between the client compute node and the central server, an energy budget of the client compute node, a time to compute a gradient update at each client compute node, and a time to perform a memory access at each client compute node.

Example 59 includes the subject matter of Example 57, wherein the action vectors comprise one or more of a sampling probability for each client compute node, a coding redundancy to be used by each client compute node for coded federated ML training, an uplink transmit power to be used by the client compute node, a bandwidth to be allocated to the client compute node, and a scaling factor to be applied to the hyper-parameters.

Example 60 includes the subject matter of Example 57, wherein the hyper-parameters determined via the reinforcement learning comprise one or more of a learning rate for the federated ML training and a weight regularization coefficient.

Example 61 includes the subject matter of any one of Examples 57-60, wherein the processor is to perform the reinforcement learning across multiple hyper-parameter scenarios using a plurality of trials.

Example 62 includes a method to be performed at an edge computing node in an edge computing network, the method comprising: performing reinforcement learning to determine hyper-parameters for federated machine learning (ML) training of an ML model, including: obtaining state information from clients of the edge computing network; selecting a set of action vectors corresponding to the hyper-parameters; performing rounds of a federated ML training within the edge computing network using the action vectors to update the ML model; and determining a measure of accuracy of the updated ML model; and performing rounds of a federated ML training for the ML model within the edge computing network using hyper-parameters determined via the reinforcement learning.

Example 63 includes the subject matter of Example 62, wherein the state information comprises one or more of statistics of ML parameter updates from each client compute node of the edge computing network, a cosine similarity of ML parameter updates from each client compute node, loss metrics for each client compute node, a learning rate for each client compute node, a number of local federated ML training epochs performed by each client compute node, a number training data samples used by each client compute node, an average data rate supported between the client compute node and the central server, an energy budget of the client compute node, a time to compute a gradient update at each client compute node, and a time to perform a memory access at each client compute node.

Example 64 includes the subject matter of Example 62, wherein the action vectors comprise one or more of a sampling probability for each client compute node, a coding redundancy to be used by each client compute node for coded federated ML training, an uplink transmit power to be used by the client compute node, a bandwidth to be allocated to the client compute node, and a scaling factor to be applied to the hyper-parameters.

Example 65 includes the subject matter of Example 62, wherein the hyper-parameters determined via the reinforcement learning comprise one or more of a learning rate for the federated ML training and a weight regularization coefficient.

Example 66 includes the subject matter of any one of Examples 57-65, further comprising performing the reinforcement learning across multiple hyper-parameter scenarios using a plurality of trials.

Example P1 includes method to be performed at an apparatus of an edge compute node in an edge computing network, the method including: selecting a subset of client edge compute nodes; transmitting a global weight for a global machine learning model to the selected client edge compute nodes; receiving model update information from the selected client edge compute nodes based on the transmitted global weight; and updating the global weight based on the received model update information.

Example P2 includes the subject matter of Example P1, and/or some other example(s) herein, and optionally, wherein the model update information comprises local meta update information for local machine learning models at the selected client edge compute nodes.

Example P3 includes the subject matter of Example P1, and/or some other example(s) herein, and optionally, wherein the model update information comprises updated local weights for local machine learning models at the selected client edge compute nodes, and Hessian values.

Example P4 includes the subject matter of Example P1, and/or some other example(s) herein, and optionally, wherein the subset of client edge compute nodes are selected randomly.

Example P5 includes the subject matter of Example P1, and/or some other example(s) herein, and optionally, wherein the subset of client edge compute nodes are selected based on a clustering algorithm.

Example P6 includes the subject matter of Example P4, and/or some other example(s) herein, and optionally, wherein the clustering algorithm utilizes a K-means clustering algorithm.

Example P7 includes the subject matter of any one of Examples P1-P6, and/or some other example(s) herein, and optionally, wherein the edge compute node is a server, such as a central server.

Example P8 includes method to be performed at an apparatus of an edge compute node in an edge computing network, the method including: obtaining, from a central server, a global weight for a global machine learning model; performing, at the edge compute node, a local meta update to a local machine learning model, wherein performing the local meta update comprises: performing a local gradient update based on a first local dataset for the edge compute node; updating a local weight for the local machine learning model based on the gradient; determining a Hessian based on the gradient; and causing the local meta update to be transmitted to the central server to update the global machine learning model.

Example P9 includes the subject matter of Example P8, and/or some other example(s) herein, and optionally, wherein performing the local meta update is done iteratively.

Example P10 includes the subject matter of Example P8, and/or some other example(s) herein, and optionally, wherein performing the local meta update further comprises evaluating the gradient corresponding to a different local dataset using the computed local weight.

Example P11 includes method to be performed at an apparatus of an edge compute node in an edge computing network, the method including: obtaining, from a central server, a global weight for a global machine learning model; performing a local gradient update based on a first local dataset for the edge compute node; updating a local weight for the local machine learning model based on the gradient; determining a Hessian based on the gradient; and causing the updated local weight and Hessian to be transmitted to the central server to update the global machine learning model.

Example P12 includes the subject matter of any one of Examples P8-P11, and/or some other example(s) herein, and optionally, wherein the edge compute node is a client device of an edge computing system.

Example PP1 includes method to be performed at an apparatus of an edge compute node in an edge computing network, the method including: determining a data batch size for each of a plurality of clients of the edge computing network, wherein the data batch size for each client is based on compute capabilities of the client and indicates a number of training examples to be used by the client in performing a round of federated machine learning training; causing the data batch size determined for each client to be sent to the corresponding client; performing a round of a federated machine learning training within the edge computing network including: selecting a set of clients from the plurality of clients to participate in said round of the federated machine learning training; causing a global model of the machine learning training to be sent to the selected set of clients; and processing updated model weight information for the federated machine learning training obtained from the selected clients, the updated model weight information based on computations performed by each client using the data batch size indicated for the particular client; and updating the global model based on processing the information.

Example PP2 includes the subject matter of Example PP1, and/or some other example(s) herein, and optionally, further comprising processing compute model information for each of the plurality of clients, the compute model information indicating a compute time for the respective client to complete a federated machine learning training round as a function of a number of training examples used in said federated machine learning training round, wherein the data batch size determined for each client is based on the compute model information for the particular client.

Example PP3 includes the subject matter of Example PP1, and/or some other example(s) herein, and optionally, further comprising determining a minimum data batch size based on a range boundary for a variance in a computed model weight gradient.

Example PP4 includes the subject matter of Example PP3, and/or some other example(s) herein, and optionally, further comprising determining a nominal compute time indicating an amount of time for a slowest client to complete a federated machine learning training round using the minimum data batch size.

Example PP5 includes the subject matter of Example PP4, and/or some other example(s) herein, and optionally, wherein the data batch size for each client is based on the nominal compute time.

Example PP6 includes the subject matter of any one of Examples PP1-PP5, and/or some other example(s) herein, and optionally, wherein selecting the set of clients is based on the number of data batches at each client.

Example PP7 includes the subject matter of any one of Examples PP1-PP6, and/or some other example(s) herein, and optionally, further comprising obtaining information from a client indicating that the data batch size for said client is too small to maintain a model weight gradient within a range from a true model weight gradient that is based on performing a federated machine learning training round using all training examples at said client.

Example PP8 includes the subject matter of any one of Examples PP1-PP7, and/or some other example(s) herein, and optionally, wherein the updated model weight information is based on a gradient-based analysis.

Example PP9 includes the subject matter of any one of Examples PP1-PP8, and/or some other example(s) herein, and optionally, wherein the edge compute node is a server, such as a MEC server.

Example PP10 includes method to be performed at an apparatus of an edge compute node in an edge computing network, the method including: determining a reference time indicating an amount of time in which clients are to perform a round of federated machine learning training; causing the reference time to be sent to each of a plurality of clients of the edge computing network; obtaining data batch size information from each client indicating a number of training examples to be used by the client to perform a round of federated machine learning training within the reference time; performing a round of a federated machine learning training within the edge computing network including: selecting a set of clients from the plurality of clients to participate in said round of the federated machine learning training; causing a global model of the machine learning training to be sent to the selected set of clients; and processing updated model weight information for the federated machine learning training obtained from the selected clients, the updated model weight information based on computations performed by each client using the data batch size indicated for the particular client; and updating the global model based on processing the information.

Example PP11 includes the subject matter of Example PP10, and/or some other example(s) herein, and optionally, wherein the reference time is determined based on information associated with previous federated machine learning training rounds.

Example PP12 includes the subject matter of Example PP11, and/or some other example(s) herein, and optionally, further comprising determining an estimated compute model for each client, the compute model indicating a compute time for the particular client to complete a federated machine learning training round as a function of a number of training examples used in said federated machine learning training round, wherein the reference time is determined based on the compute models for the plurality of clients.

Example PP13 includes the subject matter of any one of Examples PP10-PP12, and/or some other example(s) herein, and optionally, further comprising obtaining, from each client, a number of data batches at the client, wherein selecting the set of clients is based on the number of data batches at each client.

Example PP14 includes the subject matter of any one of Examples PP10-PP13, and/or some other example(s) herein, and optionally, further comprising obtaining information from a client indicating that the reference time is too small to maintain a model weight gradient within a range from a true model weight gradient that is based on performing a federated machine learning training round using all training examples at said client.

Example PP15 includes the subject matter of any one of Examples PP10-PP14, and/or some other example(s) herein, and optionally, wherein the updated model weight information is based on a gradient-based analysis.

Example PP16 includes the subject matter of any one of Examples PP10-PP15, and/or some other example(s) herein, and optionally, wherein the edge compute node is a server, such as a MEC server.

Example PP17 includes method to be performed at an apparatus of an edge compute node in an edge computing network, the method including: performing reinforcement learning to determine hyper-parameters of a machine learning model, including: obtaining state information from clients of the edge computing network; selecting a set of action vectors corresponding to the hyper-parameters; performing rounds of a federated machine learning training within the edge computing network using the action vectors to update the machine learning model; determining a measure of accuracy between the updated model; and performing rounds of a federated machine learning training for the machine learning model within the edge computing network using hyper-parameters determined via the reinforcement learning.

Example PP18 includes the subject matter of Example PP17, and/or some other example(s) herein, and optionally, wherein the state information includes one or more of: a number of training examples at the client, an average data rate supported by the client, an amount of time needed by the client to compute a gradient per training example, a measure of an amount of time to perform memory accesses at the client, and an energy budget for the client to perform machine learning.

Example PP19 includes the subject matter of Example PP17 or PP18, and/or some other example(s) herein, and optionally, wherein the state information is obtained in response to a broadcast request sent to the clients.

Example PP20 includes the subject matter of any one of Examples PP17-PP19, and/or some other example(s) herein, and optionally, wherein the set of action vectors includes one or more of: a vector indicating sampling probabilities for each of the clients, a vector indicating a coding redundancy corresponding to the training examples at the clients, a vector indicating uplink transmit power for the clients, a vector indicating a bandwidth assigned to the clients, and a learning rate for the federated learning.

Example PP21 includes the subject matter of any one of Examples PP17-PP20, and/or some other example(s) herein, and optionally, wherein the machine learning model is updated during the reinforcement learning using a gradient-based analysis.

Example PP22 includes the subject matter of any one of Examples PP17-PP20, and/or some other example(s) herein, and optionally, wherein the machine learning model is updated during the reinforcement learning using a Q-learning analysis.

Example PP23 includes the subject matter of any one of Examples PP17-PP22, and/or some other example(s) herein, and optionally, wherein the edge compute node is a server, such as a MEC server.

### ADDITIONAL EXAMPLES

Example L1 includes an apparatus comprising means to perform one or more elements of a method of any one of Examples 18-34, 44-52, 54, 56, 62-66, P1-P12, and PP1-PP23.

Example L2 includes one or more non-transitory computer-readable media comprising instructions to cause an electronic device, upon execution of the instructions by one or more processors of the electronic device, to perform one or more elements of a method of any one of Examples 18-34, 44-52, 54, 56, 62-66, P1-P12, and PP1-PP23.

Example L3, includes a machine-readable storage including machine-readable instructions which, when executed, implement the method of any one of Examples 18-34, 44-52, 54, 56, 62-66, P1-P12, and PP1-PP23.

Example L4 includes an apparatus comprising: one or more processors and one or more computer-readable media comprising instructions that, when executed by the one or more processors, cause the one or more processors to perform the method of any of one of Examples 18-34, 44-52, 54, 56, 62-66, P1-P12, and PP1-PP23.

Example L5 includes the apparatus of any one of 1-17, 35-43, 53, 55, 57-61, further including a transceiver coupled to the processor, and one or more antennas coupled to the transceiver, the antennas to send and receive wireless communications from other edge computing nodes in the edge computing network.

Example L6 includes the apparatus of claim L5, further including a system memory coupled to the processor, the system memory to store instructions, the processor to execute the instructions to perform the training.

Example L7 includes an apparatus comprising logic, modules, or circuitry to perform one or more elements of a method described in or related to any of Examples 18-34, 44-52, 54, 56, 62-66, P1-P12, and PP1-PP23, or any other method or process described herein.

Example L8 includes a method, technique, or process as described in or related to any of Examples 18-34, 44-52, 54, 56, 62-66, P1-P12, and PP1-PP23, or portions or parts thereof.

Example L9 includes an apparatus comprising: one or more processors and one or more computer-readable media comprising instructions that, when executed by the one or more processors, cause the one or more processors to perform the method, techniques, or process as described in or related to any of Examples 18-34, 44-52, 54, 56, 62-66, P1-P12, and PP1-PP23, or portions thereof.

Example L10 includes a signal as described in or related to any of the examples herein, or portions or parts thereof.

Example L11 includes a datagram, packet, frame, segment, protocol data unit (PDU), or message as described in or related to any of the examples herein, or portions or parts thereof, or otherwise described in the present disclosure.

Example L12 includes a signal encoded with data as described in or related to any of the examples herein, or portions or parts thereof, or otherwise described in the present disclosure.

Example L13 includes a signal encoded with a datagram, packet, frame, segment, protocol data unit (PDU), or message as described in or related to any of the examples herein, or portions or parts thereof, or otherwise described in the present disclosure.

Example L14 includes an electromagnetic signal carrying computer-readable instructions, wherein execution of the computer-readable instructions by one or more processors is to cause the one or more processors to perform the method, techniques, or process as described in or related to any of Examples 18-34, 44-52, 54, 56, 62-66, P1-P12, and PP1-PP23, or portions thereof.

Example L15 includes a computer program comprising instructions, wherein execution of the program by a processing element is to cause the processing element to carry out the method, techniques, or process as described in or related to any of Examples 18-34, 44-52, 54, 56, 62-66, P1-P12, and PP1-PP23, or portions thereof.

Example L15.5 includes a message or communication between a first edge computing node and a second edge computing note, or between a client computing node and a central server, substantially as shown and described herein, wherein the message or communication is to be transmitted/received on an application programming interface (API), or, especially when used to enhance a wireless network, embedded in L1/L2/L3 layers of the protocol stack depending on the application.

Example 15.6 includes a message or communication between a first edge computing node and a second edge computing note, or between a client computing node and a central server, substantially as shown and described herein, wherein the message or communication is to be transmitted/received on a Physical (PHY) layer, or on a Medium Access Control (MAC) layer as set forth in wireless standards, such as the 802.11 family of standards, or the Third Generation Partnership Project (3GPP) Long Term Evolution (LTE) or New Radio (NR or 5G) family of technical specifications.

Example 15.7 includes a message or communication between a first edge computing node and a second edge computing note, or between a client computing node and a central server, substantially as shown and described herein, wherein the message or communication involves a parameter exchange as described above to allow an estimation of wireless spectrum efficiency, and is to be transmitted/received on a L1 layer of a protocol stack.

Example 15.8 includes a message or communication between a first edge computing node and a second edge computing note, or between a client computing node and a central server, substantially as shown and described herein, wherein the message or communication involves a prediction of edge computing node sleep patterns, and is to be transmitted/received on a L2 layer of a protocol stack.

Example 15.9 includes a message or communication between a first edge computing node and a second edge computing note, or between a client computing node and a central server, substantially as shown and described herein, wherein the message or communication is to be transmitted or received on a transport network layer, an Internet Protocol (IP) transport layer, a General Radio Packet Service Tunneling Protocol User Plane (GTP-U) layer, a User Datagram Protocol (UDP) layer, an IP layer, on a layer of a control plane protocol stack (e.g. NAS, RRC, PDCP, RLC, MAC, and PHY), on a layer of a user plane protocol stack (e.g. SDAP, PDCP, RLC, MAC, and PHY).

Example L16 includes a signal in a wireless network as shown and described herein.

Example L17 includes a method of communicating in a wireless network as shown and described herein.

Example L18 includes a system for providing wireless communication as shown and described herein.

Example NODE1 includes an edge compute node comprising the apparatus of any one of Examples 1-17, 35-43, 53, 55, 57-61, and further comprising a transceiver coupled to the processor, and one or more antennas coupled to the transceiver, the antennas to send and receive wireless communications from other edge computing nodes in the edge computing network.

Example NODE2 includes the subject matter of Example NODE1, further comprising a system memory coupled to the processor, the system memory to store instructions, the processor to execute the instructions to perform the training.

Example NODE3 includes the subject matter of Example NODE1 or NODE 2, wherein the apparatus is the apparatus of any one of Examples 1-17, 35-43, 53, 55, 57-61, and the edge compute node further comprises: a network interface card (NIC) to provide the apparatus wired access to a core network; and a housing that encloses the apparatus, the transceiver, and the NIC.

Example NODE4 includes the subject matter of Example NODE3, wherein the housing further includes power circuitry to provide power to the apparatus.

Example NODE5 includes the subject matter of any one of Examples NODE3-NODE4, wherein the housing further includes mounting hardware to enable attachment of the housing to another structure.

Example NODE6 includes the subject matter of any one of Examples NODE3-NODE5, wherein the housing further includes at least one input device.

Example NODE6 includes the subject matter of any one of Examples NODE3-NODE6, wherein the housing further includes at least one output device.

An example implementation is an edge computing system, including respective edge processing devices and nodes to invoke or perform the operations of Examples 18-34, 44-52, 54, 56, 62-66, P1-P12, and PP1-PP23, or other subject matter described herein.

Another example implementation is a client endpoint node, operable to invoke or perform the operations of Examples 18-34, 44-52, 54, 56, 62-66, P1-P12, and PP1-PP23, or other subject matter described herein.

Another example implementation is an aggregation node, network hub node, gateway node, or core data processing node, within or coupled to an edge computing system, operable to invoke or perform the operations of Examples 18-34, 44-52, 54, 56, 62-66, P1-P12, and PP1-PP23, or other subject matter described herein.

Another example implementation is an access point, base station, road-side unit, street-side unit, or on-premise unit, within or coupled to an edge computing system, operable to invoke or perform the operations of Examples 18-34, 44-52, 54, 56, 62-66, P1-P12, and PP1-PP23, or other subject matter described herein.

Another example implementation is an edge provisioning node, service orchestration node, application orchestration node, or multi-tenant management node, within or coupled to an edge computing system, operable to invoke or perform the operations of Examples 18-34, 44-52, 54, 56, 62-66, P1-P12, and PP1-PP23, or other subject matter described herein.

Another example implementation is an edge node operating an edge provisioning service, application or service orchestration service, virtual machine deployment, container deployment, function deployment, and compute management, within or coupled to an edge computing system, operable to invoke or perform the operations of Examples 18-34, 44-52, 54, 56, 62-66, P1-P12, and PP1-PP23, or other subject matter described herein.

Another example implementation is an edge computing system operable as an edge mesh, as an edge mesh with side car loading, or with mesh-to-mesh communications, operable to invoke or perform the operations of Examples 18-34, 44-52, 54, 56, 62-66, P1-P12, and PP1-PP23, or other subject matter described herein.

Another example implementation is the apparatus of any one of Examples 1-17, 35-43, 53, 55, 57-61, further including a transceiver coupled to the processor, and one or more antennas coupled to the transceiver, the antennas to send wireless communications to and to receive wireless communications from other edge computing nodes in the edge computing network.

Another example includes an apparatus substantially as shown and described herein.

Another example includes a method substantially as shown and described herein.

Another example implementation is the apparatus of the Example of the paragraph above, further including a system memory coupled to the processor, the system memory to store instructions, the processor to execute the instructions to perform the training.

Another example implementation is an edge computing system including aspects of network functions, acceleration functions, acceleration hardware, storage hardware, or computation hardware resources, operable to invoke or perform the use cases discussed herein, with use of the examples herein, or other subject matter described herein.

Another example implementation is an edge computing system adapted for supporting client mobility, vehicle-to-vehicle (V2V), vehicle-to-everything (V2X), or vehicle-to-infrastructure (V2I) scenarios, and optionally operating according to ETSI MEC specifications, operable to invoke or perform the use cases discussed herein, with use of the examples herein, or other subject matter described herein.

Another example implementation is an edge computing system adapted for mobile wireless communications, including configurations according to an 3GPP 4G/LTE or 5G network capabilities, operable to invoke or perform the use cases discussed herein, with use of the Examples above, or other subject matter described herein.

Any of the above-described Examples may be combined with any other example (or combination of examples), unless explicitly stated otherwise. Aspects described herein can also implement a hierarchical application of the scheme for example, by introducing a hierarchical prioritization of usage for different types of users (e.g., low/medium/high priority, etc.), based on a prioritized access to the spectrum e.g. with highest priority to tier-1 users, followed by tier-2, then tier-3, etc. users, etc. Some of the features in the present disclosure are defined for network elements (or network equipment) such as Access Points (APs), eNBs, gNBs, core network elements (or network functions), application servers, application functions, etc. Any embodiment discussed herein as being performed by a network element may additionally or alternatively be performed by a UE, or the UE may take the role of the network element (e.g., some or all features defined for network equipment may be implemented by a UE).

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations to provide greater bandwidth/throughput and to support edge services selections that can be made available to the edge systems being serviced. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1-77. (canceled)

78. An apparatus of an edge computing node to be operated in an edge computing network, the apparatus including an interconnect interface to connect the apparatus to one or more components of the edge computing node, and a processor to:
cause an initial set of weights for a global machine learning (ML) model to be transmitted a set of client compute nodes of the edge computing network;
process Hessians computed by each of the client compute nodes based on a dataset stored on the client compute node;
evaluate a gradient expression for the ML model based on a second dataset and an updated set of weights received from the client compute nodes; and
generate a meta-updated set of weights for the global model based on the initial set of weights, the Hessians received, and the evaluated gradient expression.

79. The apparatus of claim 78, wherein the processor is to generate the meta-updated set of weights according to:
$${w}_{t + 1} = {w}_{t} - α \frac{1}{{\sum }_{k}^{K} {n}_{k}} {\sum }_{k}^{K} {n}_{k} ( I - β {h}_{k} ) {g}_{k} ( {\overline{w}}_{t + 1}^{k} )$$
where wₜ₊₁ represents the meta-updated set of weights, wₜ represents the initial set of weights, α represents a learning rate for the ML model, I represents an identity matrix, β represents a gradient step size for the ML model, hₖ represents the Hessian from the k-th client compute node, and gₖ(w̅ₜ₊₁^{k}) represents the evaluated gradient expression of the ML model for the k-th client compute node.

80. The apparatus of claim 78, wherein the processor is to cause a selection of the set of client compute nodes randomly from a larger set of client compute nodes.

81. The apparatus of claim 78, wherein the processor is further to cause a clustering of a larger set of client compute nodes based on their data distributions and selection of the set of client compute nodes from the larger set of client compute nodes based on the clustering.

82. The apparatus of claim 81, wherein the processor is to cause the clustering based on probability mass function information or a distance metric indicating a distance between data distributions for data on the client compute nodes.

83. The apparatus of claim 82, wherein the probability mass function information includes a probability mass function of label data associated with training examples of the client compute nodes.

84. The apparatus of claim 82, wherein the distance metric is a KL-divergence metric.

85. The apparatus of claim 81, wherein the processor is to cause the selection of the set of client compute nodes based at least in part on one or more of communication capability or compute ability received from each client compute node from a larger set of client compute nodes.

86. The apparatus of claim 81, wherein the processor is to cause clustering based on Bregman's k-means clustering or affinity propagation analysis.

87. The apparatus of claim 78, wherein the dataset stored on the client and the second dataset each include a set of training examples and a set of label values associated with the training examples.

88. The apparatus of claim 78, wherein the processor is further to:
determine a data batch size for each of a plurality of client compute nodes, wherein the data batch size for each client compute node is based on compute capabilities of the client compute node and indicates a number of training examples to be used by the client compute node in performing a round of federated machine learning training; and
cause the data batch size determined for each client compute node to be transmitted to the corresponding client compute node.

89. The apparatus of claim 78, wherein the processor is further to: determine a reference time indicating an amount of time in which clients are to perform a round of federated machine learning training;
cause the reference time to be transmitted to each of a plurality of clients of the edge computing network; and
obtain data batch size information from each client indicating a number of training examples to be used by the client to perform a round of federated machine learning training within the reference time.

90. The apparatus of claim 78, wherein the processor is further to perform reinforcement learning to determine hyper-parameters for federated ML training of the global ML model, by performing operations comprising:
obtaining state information from clients of the edge computing network;
selecting a set of action vectors corresponding to the hyper-parameters;
performing rounds of a federated ML training within the edge computing network using the action vectors to update the global ML model; and
determining a measure of accuracy of the updated global ML model.

91. The apparatus of claim 90, wherein the state information comprises one or more of statistics of ML parameter updates from each client compute node of the edge computing network, a cosine similarity of ML parameter updates from each client compute node, loss metrics for each client compute node, a learning rate for each client compute node, a number of local federated ML training epochs performed by each client compute node, a number training data samples used by each client compute node, an average data rate supported between the client compute node and the central server, an energy budget of the client compute node, a time to compute a gradient update at each client compute node, and a time to perform a memory access at each client compute node.

92. The apparatus of claim 90, wherein the action vectors comprise one or more of a sampling probability for each client compute node, a coding redundancy to be used by each client compute node for coded federated ML training, an uplink transmit power to be used by the client compute node, a bandwidth to be allocated to the client compute node, and a scaling factor to be applied to the hyper-parameters.

93. The apparatus of claim 90, wherein the hyper-parameters determined via the reinforcement learning comprise one or more of a learning rate for the federated ML training and a weight regularization coefficient.

94. The apparatus of claim 90, further comprising performing the reinforcement learning across multiple hyper-parameter scenarios using a plurality of trials.

95. A method to be performed at an edge computing node in an edge computing network, the method comprising:
transmitting an initial set of weights for a global machine learning (ML) model to a set of client compute nodes of the edge computing network;
receiving, from each of the client compute nodes, a Hessian computed based on a dataset stored on the client compute node and an updated set of weights computed based on a gradient computed based on the dataset;
evaluating a gradient expression for the ML model based on the updated set of weights and a second dataset; and
generating a meta-updated set of weights for the global model based on the initial set of weights, the Hessians received, and the evaluated gradient expression.

96. The method of claim 95, wherein the meta-updated set of weights are generated according to:
$${w}_{t + 1} = {w}_{t} - α \frac{1}{{\sum }_{k}^{K} {n}_{k}} {\sum }_{k}^{K} {n}_{k} ( I - β {h}_{k} ) {g}_{k} ( {\overline{w}}_{t + 1}^{k} )$$
where wₜ₊₁ represents the meta-updated set of weights, wₜ represents the initial set of weights, α represents a learning rate for the ML model, I represents an identity matrix, β represents a gradient step size for the ML model, hₖ represents the Hessian from the k-th client compute node, and gₖ(w̅t₊₁^{k}) represents the evaluated gradient expression of the ML model for the k-th client compute node.

97. The method of claim 95, further comprising clustering a larger set of client compute nodes based on their data distributions, wherein the set of client compute nodes are selected based on the clustering.

98. The method of claim 97, wherein the clustering is based on probability mass function information or a distance metric indicating a distance between data distributions for data on the client compute nodes.

99. One or more non-transitory computer-readable media comprising instructions to cause an electronic device, upon execution of the instructions by one or more processors of the electronic device, to:
cause an initial set of weights for a global machine learning (ML) model to be transmitted a set of client compute nodes of the edge computing network;
process Hessians computed by each of the client compute nodes based on a dataset stored on the client compute node;
evaluate a gradient expression for the ML model based on a second dataset and an updated set of weights received from the client compute nodes; and
generate a meta-updated set of weights for the global model based on the initial set of weights, the Hessians received, and the evaluated gradient expression.

100. The computer-readable media of claim 99, wherein the instructions are to generate the meta-updated set of weights according to:
$${w}_{t + 1} = {w}_{t} - α \frac{1}{{\sum }_{k}^{K} {n}_{k}} {\sum }_{k}^{K} {n}_{k} ( I - β {h}_{k} ) {g}_{k} ( {\overline{w}}_{t + 1}^{k} )$$
where wₜ₊₁ represents the meta-updated set of weights, wₜ represents the initial set of weights, α represents a learning rate for the ML model, I represents an identity matrix, β represents a gradient step size for the ML model, hₖ represents the Hessian from the k-th client compute node, and gₖ(w̅t₊₁^{k}) represents the evaluated gradient expression of the ML model for the k-th client compute node.

101. The computer-readable media of claim 99, wherein the instructions are further to cause a clustering of a larger set of client compute nodes based on their data distributions and selection of the set of client compute nodes from the larger set of client compute nodes based on the clustering.

102. The computer-readable media of claim 99, wherein the clustering is based on probability mass function information or a distance metric indicating a distance between data distributions for data on the client compute nodes.
